(19) United States
(12) Patent Application Publication
(10) Pub. No.: US 2012/0030047 A1
(43) Pub. Date: Feb. 2, 2012

(54) PAYMENT TOKENIZATION APPARATUSES, METHODS AND SYSTEMS

(76) Inventors: Jacob Fuentes, London (GB); Matthew Dill, London (GB); Greg Trifiletti, San Francisco, CA (US); Peter Ciurea, Martinez, CA (US); Ayman Hammad, Pleasanton, CA (US)

(21) Appl. No.: 13/153,301

(22) Filed: Jun. 3, 2011

Related U.S. Application Data
(60) Provisional application No. 61/351,475, filed on Jun. 4, 2010.
(60) Provisional application No. 61/447,644, filed on Feb. 28, 2011.

(51) Int. Cl. G06Q 30/06

(52) U.S. Cl. 705/26.1

(57) ABSTRACT

The PAYMENT TOKENIZATION APPARATUSES, METHODS AND SYSTEMS (“PT”) transform payment token-based purchase orders via PT components into multi-issuer purchase payment funds transfers. In one embodiment, the PT obtains a token arbitration request including unique source-neutral universally-resolvable payment token information from a merchant for processing a purchase order from a user. The PT queries a token database for issuer information on an issuer using the payment token information, and obtains the issuer information. The PT also determines that the user should be queried for payment options based on the issuer information, generates a payment options request, and provides the payment options request to a mobile device of the user. Upon obtaining a response to the payment options request from the mobile device of the user, the PT generates a purchase authorization request based on the payment options and pre-defined settings for issuers to be contacted for processing the purchase order, and provides the generated purchase authorization request to the issuer.

### RELATED APPLICATIONS

Applicant hereby claims priority under 35 USC §119 for: U.S. provisional patent application Ser. No. 61/351,475 filed Jun. 4, 2010, entitled “SYSTEM AND METHOD USING MERCHANT PAYMENT OPTIONS,” attorney docket no. P-41572PRV|20270-152PV; and U.S. provisional patent application Ser. No. 61/447,644 filed Feb. 28, 2011, entitled “SECURE ANONYMOUS TRANSACTION APPARATUSES, METHODS AND SYSTEMS,” attorney docket no. P-42055PRV|20270-137PV. The entire contents of the aforementioned applications are expressly incorporated herein by reference.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present inventions are directed generally to apparatuses, methods, and systems for purchase transactions, and more particularly, to PAYMENT TOKENIZATION APPARATUSES, METHODS AND SYSTEMS (“PT”).

### BACKGROUND

Card-based consumer transactions typically require a customer to enter numerous details of a credit or debit card, or utilize a payment method such as cash or check. Engaging in card transactions requires transmission of personal information to a wide range of third-party merchants.

### BRIEF DESCRIPTION OF THE DRAWINGS

The accompanying appendices and/or drawings illustrate various non-limiting, example, inventive aspects in accordance with the present disclosure:

FIG. 1 shows a block diagram illustrating example aspects of payment tokenization in some embodiments of the PT;

FIGS. 2A-B shows application user interface diagrams illustrating example features of application interfaces for controlling tokenized payments for purchase transactions in some embodiments of the PT;

FIGS. 3A-C show application user interface diagrams illustrating example features of a payment tokenization mobile app for securing user data and preventing fraud in some embodiments of the PT;

FIG. 4 shows a data flow diagram illustrating an example procedure to enroll in a token-based purchase payment program in some embodiments of the PT;

FIG. 5 shows a logic flow diagram illustrating example aspects of enrolling in a token-based purchase payment program in some embodiments of the PT, e.g., a Token-Based Purchase Enrollment (“TPE”) component 500;

FIGS. 6A-E show data flow diagrams illustrating an example procedure to execute a token-based purchase transaction in some embodiments of the PT;

FIGS. 7A-F show logic flow diagrams illustrating example aspects of executing a token-based purchase transaction in some embodiments of the PT, e.g., a Token-Based Purchase Transaction Execution (“tPTE”) component 700; and

FIG. 8 shows a block diagram illustrating embodiments of a PT controller.

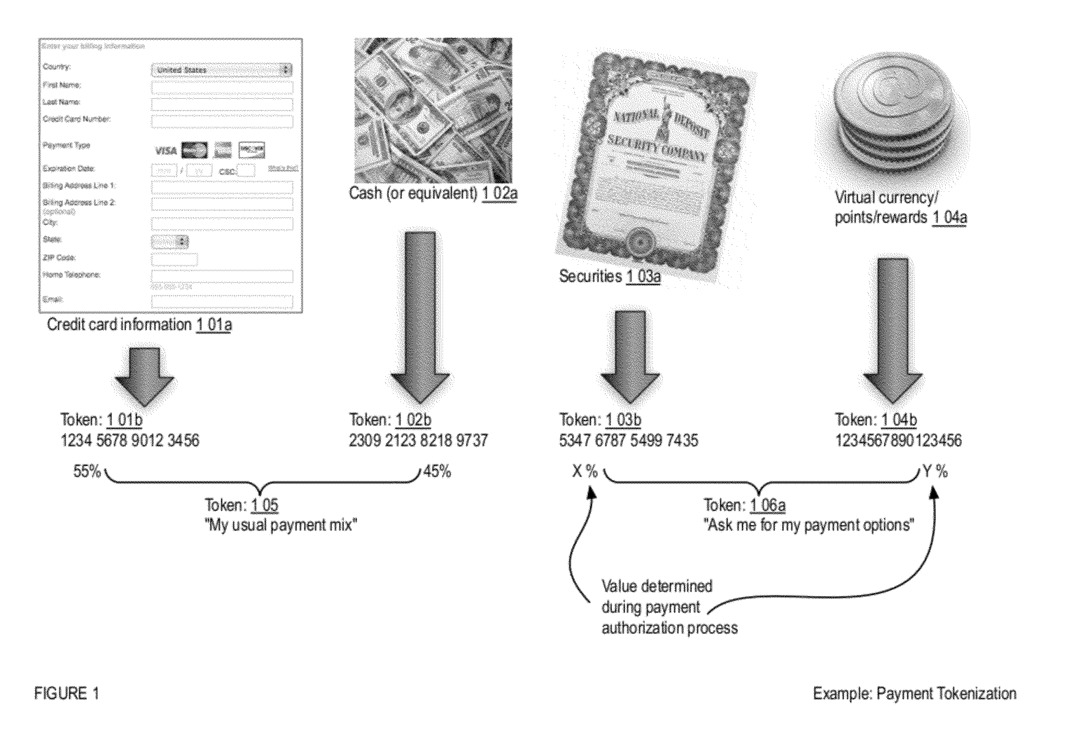

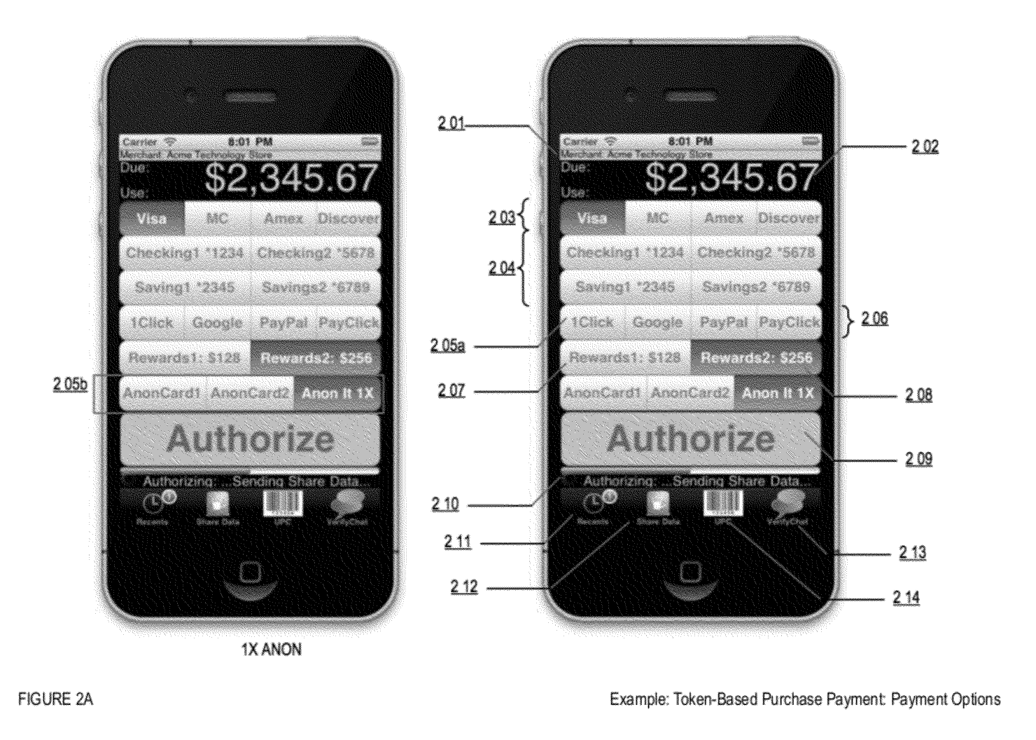

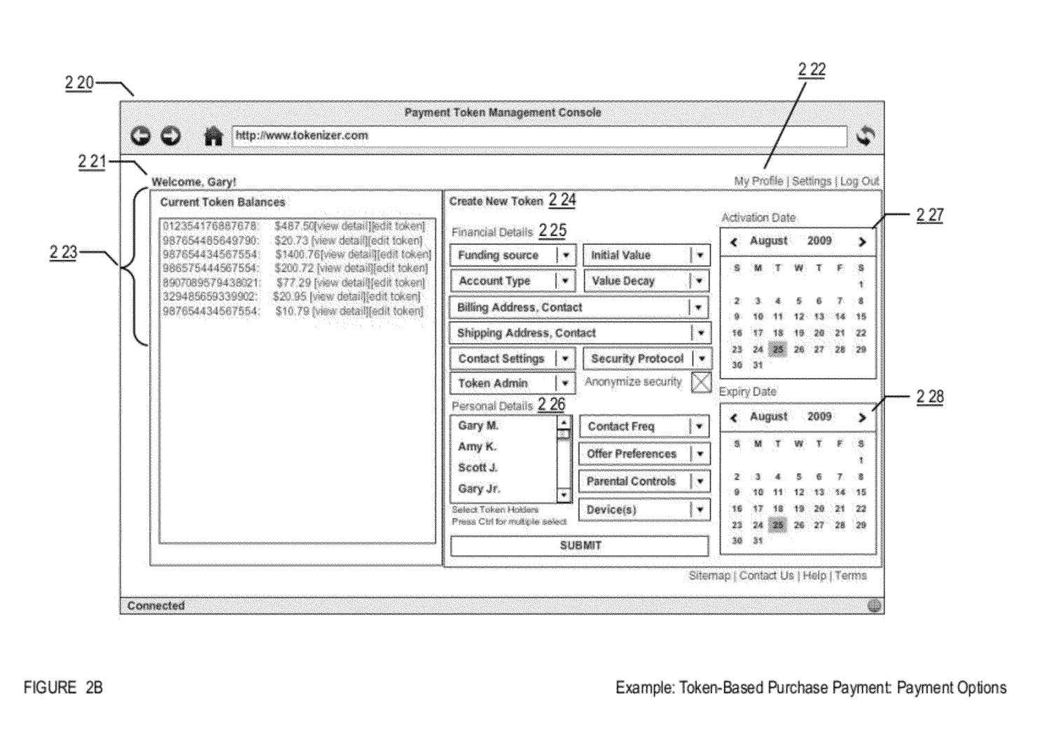

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Payment Tokenization (PT)

The PAYMENT TOKENIZATION APPARATUSES, METHODS AND SYSTEMS (hereinafter “PT”) transform payment token-based purchase orders, via PT components, into multi-issuer purchase payment funds transfers.

FIG. 1 shows a block diagram illustrating example aspects of payment tokenization in some embodiments of the PT. In some implementations, a user may desire to purchase a product, service and/or other offering (“product”) from a merchant, e.g., 106. The user may desire to utilize a card (e.g., debit, credit, prepaid, etc.), e.g., 101a, cash (or its equivalent), e.g., 102a, securities, e.g., 103a, virtual currency, rewards, points, miles, etc., e.g., 104a, and/or other payment options. However, the user may wish to maintain anonymity to prevent personal information of the user from being collected by the merchant. As another example, the user may be wary of the user's card data being misused to conduct fraudulent transactions. In some implementations, the user may be able to utilize aliases, or tokens in lieu of payment information. For example, the user may be able to pass a token, e.g., 101b, 102b, 103b, 104b, to a merchant instead of complete card information, cash or account information. A secure token arbitrator may operate in conjunction with the merchant to process the transaction. For example, upon receiving a payment token from the user, the merchant may pass the token to a transaction arbitrator. The secure transaction arbitrator may have the ability to parse the incoming token, and determine the identity of the user for that token. The transaction arbitrator may also determine financial payment information to use to process the transaction. In some implementations, the transaction arbitrator may also only have another token stored as payment information. In such implementations, the issuer of the token may be the only entity other than the user to know the actual personal and/or financial information of the user. Thus, in some implementations, a token may comprise a combination of other token. For example, a token held by the transaction arbitrator may point to other token held by the transaction arbitrator and/or the issuer. Thus, in some implementations, multiple layers of security of personal and financial information may be generated by structuring the payment tokens accordingly. In some implementations, a token may specify a composition, including a mix of other payment tokens. For example, a payment token 105 may indicate that the transaction may be processed by assigning a percentage (e.g., 55%) of the transaction cost to a token 101b (e.g., linked to credit card information iota ultimately), and a different percentage (e.g., 45%) to a different token 102b (e.g., linked to a stored cash account 101a ultimately). In some implementations, the percentages may be determined in real-time or near real-time. For example, the token arbitrators may operate in conjunction with the issuers having user accounts linked to the payment token to determine which of the user accounts should be charged, and how much should be charged to each user account (e.g., in accordance with a predetermined algorithm). As another example, the percentages may be determined only at the time of processing the transaction, see, e.g., 103b, 104b, for example by requesting the user to provide payment options at the time of processing the purchase transaction.

In some implementations, additional security may be layered by using authentication methods. As an example, a user may be required to provide a user name and password to activate a payment token. As another example, a user may be required to provide a digital certificate to verify the user's identity prior to utilization of a payment token for a purchase transaction. As another example, device fingerprinting may be utilized. For example, a client device of a user may be a device that is used exclusively by the user, such as a smartphone, tablet computer, laptop computer, and/or the like. In some implementations, a custom hardware authentication chip, e.g., 103, may be disposed in communication with the client. In various implementations, the chip may be embedded into the client, come pre-installed in the client, attached as a periphery to the client, and/or the like. In some implementations, the user may perform an authentication procedure with the client and a user's card linked to the user's payment token. For example, the authentication chip may be configured to recognize the user's payment token physical card when the card is in the vicinity of the authentication chip. For example, the authentication chip and the card may communicate signals via Bluetooth™, Wi-Fi™, RFID tags, cellular connectivity (e.g., 3G, 4G), and/or the like. Thus, in order to make purchase with the payment token, in some implementations, the user may be required to present the payment token physical card to the authentication chip disposed in communication with the client before the user can make a purchase order using the token. Thus, the system provides an authenticity shield preventing others who may know of the user's payment token from utilizing the user's payment token in a fraudulent transaction.

FIGS. 2A-B shows application user interface diagrams illustrating example features of application interfaces for controlling tokenized payments for purchase transactions in some embodiments of the PT. In some implementations, an app executing on the device of the user may include an app interface providing various features for the user. In some implementations, the app may include an indication of the location (e.g., name of the merchant store, geographical location, information about the aisle within the merchant store, etc.) of the user, e.g., 201. The app may provide an indication of a pay amount due for the purchase of the product, e.g., 202. In some implementations, the app may provide various options for the user to pay the amount for purchasing the product(s). For example, the app may utilize the GPS coordinates to determine the merchant store within the user is present, and direct the user to a website of the merchant. In some implementations, the PT may provide an API for participating merchants directly to facilitate transaction processing. In some implementations, a merchant-branded PT application may be developed with the PT functionality, which may directly connect the user into the merchant's transaction processing system. For example, the user may choose from a number of cards (e.g., credit cards, debit cards, prepaid cards, etc.) from various card providers, e.g., 203. In some implementations, the app may provide the user the option to pay the purchase amount using funds included in a bank account of the user, e.g., a checking, savings, money market, current account, etc., e.g., 204. In some implementations, the user may have set default options for which card, bank account, etc. to use for the purchase transactions via the app. In some implementations, such setting of default options may allow the user to initiate the purchase transaction via a single click, tap, swipe, and/or other remedial user input action, e.g., 205. In some implementations, when the user utilizes such an option, the app may utilize the default settings of the user to initiate the purchase transaction. In some implementations, the app may allow the user to utilize other accounts (e.g., Google™ Checkout, Paypal™ account, etc.) to pay for the purchase transaction, e.g., 206. In some implementations, the app may allow the user to utilize rewards points, airline miles, hotel points, electronic coupons, printed coupons (e.g., by capturing the printed coupons similar to the product identifier) etc., to pay for the purchase transaction, e.g., 207-208. In some implementations, the app may provide an option to provide express authorization before initiating the purchase transaction, e.g., 209. In some implementations, the app may provide a progress indicator provide indication on the progress of the transaction after the user has selected an option to initiate the purchase transaction, e.g., 210. In some implementations, the app may provide the user with historical information on the user's prior purchases via the app, e.g., 211. In some implementations, the app may provide the user with an option to share information about the purchase (e.g., via email, SMS, wall posting on Facebook®, tweet on Twitter™, etc.) with other users, e.g., 212. In some implementations the app may provide the user an option to display the product identification information captured by the client device (e.g., in order to show a customer service representative at the exit of a store the product information), e.g., 214. In some implementations, the user, app, device and or PT may encounter an error in the processing. In such scenarios, the user may be able to chat with a customer service representative (e.g., VerifyChat 213) to resolve the difficulties in the purchase transaction procedure.

In some implementations, the user may select to conduct the transaction using a one-time token, e.g., an anonymized credit card number, see e.g., 205b. For example, the PT may utilize a tokenized and anonymized set of card details (see, e.g., “AnonCard1,” “AnonCard2”). As another example, the PT may generate, e.g., in real-time, a one-time anonymous set of card details to securely complete the purchase transaction (e.g., “Anon It 1X”). In such implementations, the app may automatically set the user profile settings such that the any personal identifying information of the user will not be provided to the merchant and/or other entities. For example, the app may automatically send only a token or alias in lieu of payment information. The payment system may process the token to obtain its associated payment information for processing the purchase transaction. In some implementations, the user may be required to enter a user name and password to enable the anonymization features.

In some implementations, a user may be able to control the attributes of each token associated with the user via a web interface, e.g., 220. For example, the user may be able to login to the web interface, e.g., 221, and visualize payment tokens associated with the user, e.g., 223. The user may also be provided with user interface elements to generate new tokens. For example, the user interface may provide elements for creating a new token, e.g., 224. For example, the user interface may allow the user to select financial details 225 such as, but not limited to: a funding source from whom to obtain a token, an account type for the token, an initial token value (e.g., for pre-funding, and/or pore-authorization), a value decay option (e.g., to assist with time-controlled spending controls for the user), billing address information, shipping address information, contact settings, a security protocol, token administrator, user anonymization (for security) option and/or the like. In some implementations, the web interface may allow the user to select personal details 226 such as, but not limited to: token holders, contact frequency (e.g., for token offers), token offer preferences, parental controls, activated devices, and/or the like. In some implementations, the web interface may allow the user to specify activation 227 and expiry 228 dates for the tokens.

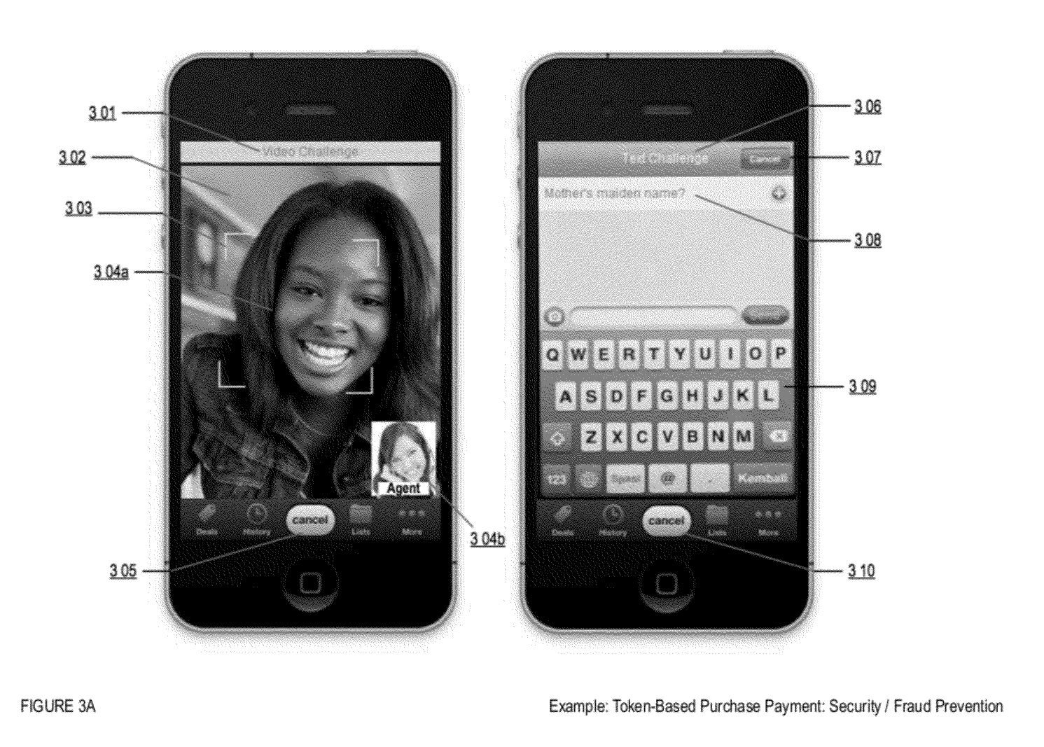

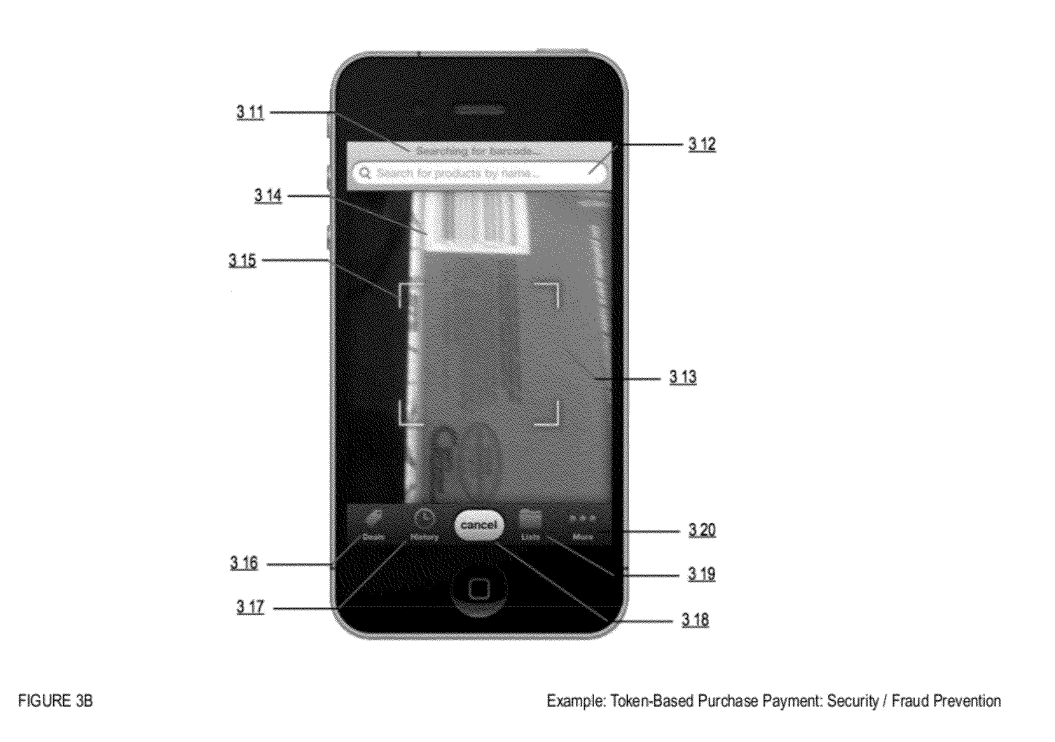

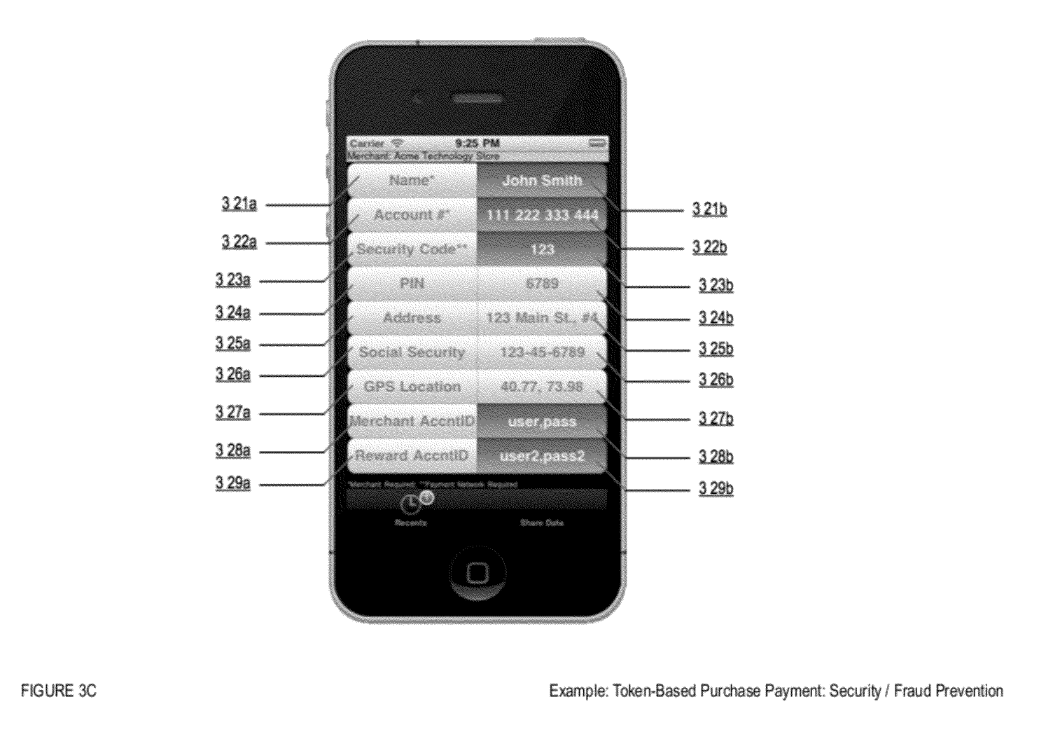

FIGS. 3A-C show application user interface diagrams illustrating example features of a payment tokenization mobile app for securing user data and preventing fraud in some embodiments of the PT. In some implementations, the app executing on the user's device may provide a “VerifyChat” feature for fraud prevention (e.g., by activating UI element 213 in FIG. 2). For example, the PT may detect an unusual and/or suspicious transaction. The PT may utilize the VerifyChat feature to communicate with the user, and verify the authenticity of the originator of the purchase transaction. In various implementations, the PT may send electronic mail message, text (SMS) messages, Facebook® messages, Twitter™ tweets, text chat, voice chat, video chat (e.g., Apple FaceTime), and/or the like to communicate with the user. For example, the PT may initiate a video challenge for the user, e.g., 301. For example, the user may need to present him/her-self via a video chat, e.g., 302. In some implementations, a customer service representative, e.g., agent 304b, may manually determine the authenticity of the user using the video of the user. In some implementations, the PT may utilize face, biometric and/or like recognition (e.g., using pattern classification techniques) to determine the identity of the user, e.g., 304a. In some implementations, the app may provide reference marker (e.g., cross-hairs, target box, etc.), e.g., 303, so that the user may the video to facilitate the PT′ automated recognition of the user. In some implementations, the user may not have initiated the transaction, e.g., the transaction is fraudulent. In such implementations, the user may cancel, e.g., 305, the challenge. The PT may then cancel the transaction, and/or initiate fraud investigation procedures on behalf of the user.

In some implementations, the PT may utilize a text challenge procedure to verify the authenticity of the user, e.g., 306. For example, the PT may communicate with the user via text chat, SMS messages, electronic mail, Facebook® messages, Twitter™ tweets, and/or the like. The PT may pose a challenge question, e.g., 308, for the user. The app may provide a user input interface element(s) (e.g., virtual keyboard 309) to answer the challenge question posed by the PT. In some implementations, the challenge question may randomly selected by the PT automatically; in some implementations, a customer service representative may manually communicate with the user. In some implementations, the user may not have initiated the transaction, e.g., the transaction is fraudulent. In such implementations, the user may cancel, e.g., 307, 310, the text challenge. The PT may then cancel the transaction, and/or initiate fraud investigation procedures on behalf of the user.

In some implementations, the app may be configured to recognize product identifiers (e.g., barcodes, QR codes, etc.). For example, for fraud prevention, the app may require the user to utilize the user's device to obtain snapshot of the items being purchased, thus ensuring that the person who swiped the card is also in possession of the user's device as well as the purchase items. In some implementations, the user may be required to sign in to the app to enable its features. Once enabled, the camera may provide in-person one tap purchasing features for the user. For example, the client device may have a camera via which the app may acquire images, video data, streaming live video, and/or the like, e.g., 313. The app may be configured to analyze the incoming data, and search, e.g., 311, for a product identifier, e.g., 314. In some implementations, the app may overlay cross-hairs, target box, and/or like alignment reference markers, e.g., 315, so that a user may align the product identifier using the reference markers so facilitate product identifier recognition and interpretation. In some implementations, the app may include interface elements to allow the user to switch back and forth between the product identification mode and the product offer interface display screens (see, e.g., 316), so that a user may accurately study the deals available to the user before capturing a product identifier. In some implementations, the app may provide the user with the ability to view prior product identifier captures (see, e.g., 317) so that the user may be able to better decide which product identifier the user desires to capture. In some implementations, the user may desire to cancel product purchasing; the app may provide the user with a user interface element (e.g., 318) to cancel the product identifier recognition procedure and return to the prior interface screen the user was utilizing. In some implementations, the user may be provided with information about products, user settings, merchants, offers, etc. in list form (see, e.g., 319) so that the user may better understand the user's purchasing options. Various other features may be provided for in the app (see, e.g., 320).

In some implementations, the user may be able to view and/or modify the user profile and/or settings of the user, e.g., by activating user interface element 309 (see FIG. 3A). For example, the user may be able to view/modify a user name (e.g., 321a-b), account number (e.g., 322a-b), user security access code (e.g., 323a-b), user pin (e.g., 324a-b), user address (e.g., 325a-b), social security number associated with the user (e.g., 326a-b), current device GPS location (e.g., 327a-b), user account of the merchant in whose store the user currently is (e.g., 328a-b), the user's rewards accounts (e.g., 329a-b), and/or the like. In some implementations, the user may be able to select which of the data fields and their associated values should be transmitted to facilitate the purchase transaction, thus providing enhanced data security for the user. For example, in the example illustration in FIG. 3C, the user has selected the name 312a, account number 322a, security code 323a, merchant account ID 328a and rewards account ID 329a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the PT with the GPS location of the user. Based on the GPS location of the user, the PT may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

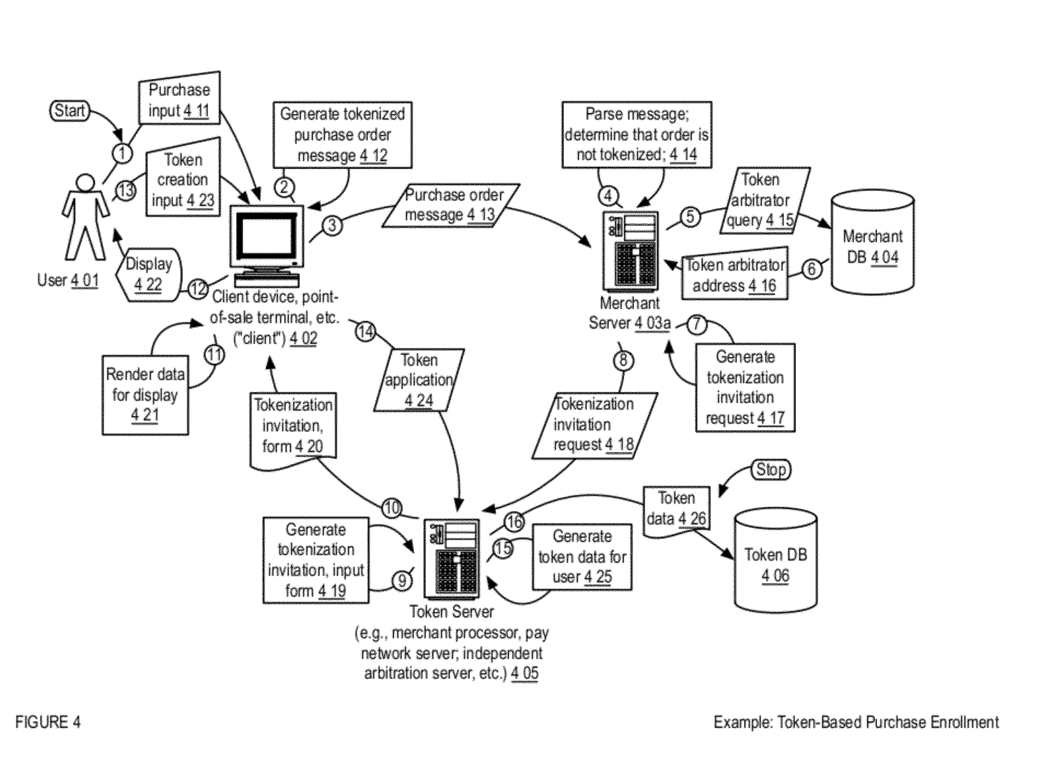

FIG. 4 shows a data flow diagram illustrating an example procedure to enroll in a token-based purchase payment program in some embodiments of the PT. In some implementations, a user, e.g., 401, may desire to purchase a product, service, offering, and/or the like (“product”), from a merchant. The user may communicate with a merchant server, e.g., 403a, via a client such as, but not limited to: a personal computer, mobile device, television, point-of-sale terminal, kiosk, ATM, and/or the like (e.g., 402). For example, the user may provide user input, e.g., purchase input 411, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, the client may generate a purchase order message, e.g., 412, and provide, e.g., 413, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. Based on the parsing, the merchant server may determine that the purchase order message is not tokenized, e.g., 414. Upon determining that the purchase order message is not tokenized, the merchant server may determine that the user needs to be provided with an option to sign up for payment tokenization services. The merchant server may attempt to identify a token arbitrator to provide the payment tokenization services for the user. For example, the merchant server may query, e.g., 415, a merchant database, e.g., 404, for an address of a token arbitrator. For example, the merchant server may utilize a hypertext preprocessor (“PHP”) script including Structured Query Language (“SQL”) commands to query a relational database for an address of a token arbitrator. An example PHP/SQL listing for querying a database for a token arbitrator address is provided below:

<?PHP
header(′Content-Type: text/plain′);
mysql_connect(“254.93.179.112”,$DBserver,$password); // access
database server
mysql_select_db(“ARBITRATORS.SQL”); // select database table to
search
//create query for token arbitrators
$query = “SELECT arbitrator_id, arbitators_name arbitrator_address

arbitrator_URL FROM TokenizationTable WHERE user_card_num
LIKE ′%′ $userpaymentcardnumber”;

$result = mysql_query($query); // perform the search query
mysql_close(“ARBITRATORS.SQL”); // close database access
?>

In response, the merchant database may provide the token arbitrator address, e.g., 416. The merchant server may generate a tokenization invitation request on behalf of the user, e.g., 417, and provide the tokenization invitation request to a token server, e.g., 405. For example, the merchant server may provide a HTTP(S) POST message including the tokenization invitation request similar to the example below:

POST /inviterequest.php HTTP/1.1
Host: www.tokenizer.com
Content-Type: Application/XML
Content-Length: 579
<?XML version = “1.0” encoding = “UTF-8”?>
<invitation_request>

<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</invitation_request>

In some implementations, the token server may parse the invitation request message, and extract details of the user and client from the message. The token server may generate, e.g., 419, a tokenization invitation and an application form for the user to complete to sign up for tokenization services. The token server may provide, e.g., 420, the tokenization invitation and the application form to the client (either directly to the client or via the merchant server). For example, the token server may provide a HTTP(S) POST message including XML data representative of the application form, such as the example HTTP(S) POST message below:

POST /purchase.php HTTP/1.1
Host: www.merchant.com
Content-Type: Application/XML
Content-Length: 1306
<?XML version = “1.0” encoding = “UTF-8”?>
<token_application_form>

<provisional_token_ID>4NFU4RG94</provisional_token_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<account_params>

<account_name> COMPLETE </account_name>
<account_type> COMPLETE </account_type>
<account_num>1234 COMPLETE
56789012345</account_num>
<billing_address> COMPLETE </billing_address>
<phone> COMPLETE </phone>
<sign> COMPLETE </sign>
<confirm_type> COMPLETE </confirm_type>
<contact_info> COMPLETE </contact_info>

</account_params>
<shipping_info>

<shipping_adress> COMPLETE </shipping_address>
<ship_type> COMPLETE </ship_type>
<ship_carrier> COMPLETE </ship_carrier>
<ship_account> COMPLETE </ship_account>
<tracking_flag> COMPLETE </tracking_flag>
<sign_flag> COMPLETE </sign_flag>

</shipping_info>

</token_application_form>

The client may render, e.g., 421, the tokenization invitation and application form, and display, e.g., 422, the invitation and application form for the user, e.g., 423. In some implementations, the user may desire to enroll for payment tokenization services, and may provide token creation input to complete the application form, e.g., 423. The client may generate a competed application form, and provide, e.g., 424, the token application to the token server (either directly or via the merchant server). For example, the client may provide a HTTP(S) POST message similar to the example above. The token server may obtain the application form, and parse the form to extract data fields and values from the form to generate a token data record, e.g., 425. The token server may store the data extracted from the application form to a token database, e.g., 406. For example, the token server may issue PHP/SQL commands similar to the example below:

<?PHP
header(′Content-Type: text/plain′);
mysql_connect(″254.92.185.103”,$DBserver,$password); // access
database server
mysql_select(″TOKENS.SQL″); // select database to append
mysql_query(“INSERT INTO PaymentTokensTable (timestamp,

token_id, user_id, user_name, client_id, client_type,
client_model, client_OS, app_installed_flag,
account_params_list, account_name, account_type, account_num,
billing_addres, zipcode, phone, sign, merchant_params_list,
merchant_id, merchant_name, merchant_auth_key)

VALUES (time( ), $userid, $username, $clientid, $clienttype,

$clientmodel, $clientOS, $appflag, $purchase_summary_list,
$num_products, $product_summary, $product_quantity,
$transaction_cost, $account_params_list, $account_name,
$account_type, $account_num, $billing_addres, $zipcode, $phone,
$sign, $merchant_params_list, $merchant_id, $merchant_name,
$merchant_auth_key)”); // add data to table in database

mysql_close(″TOKENS.SQL″); // close connection to database
?>

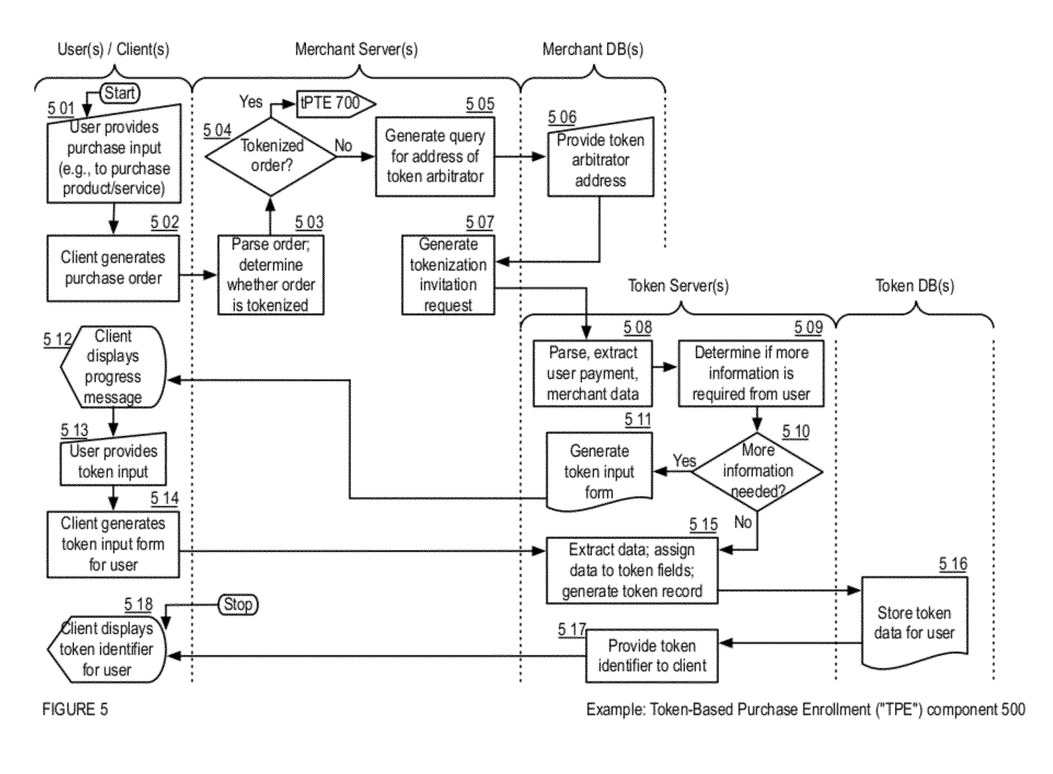

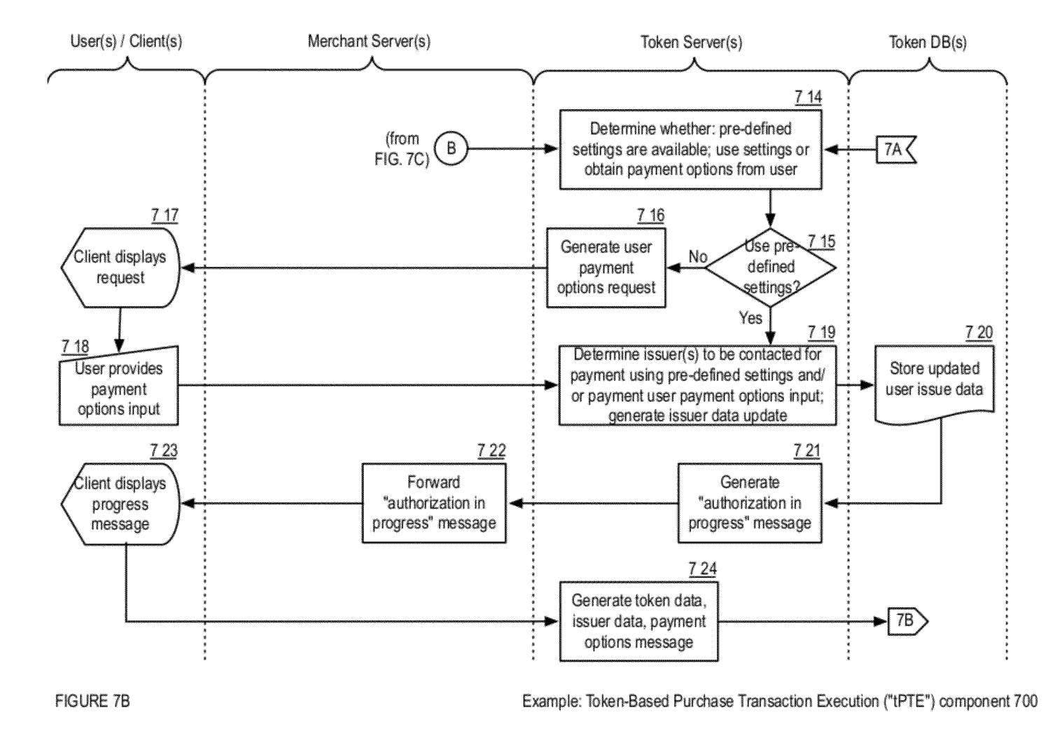

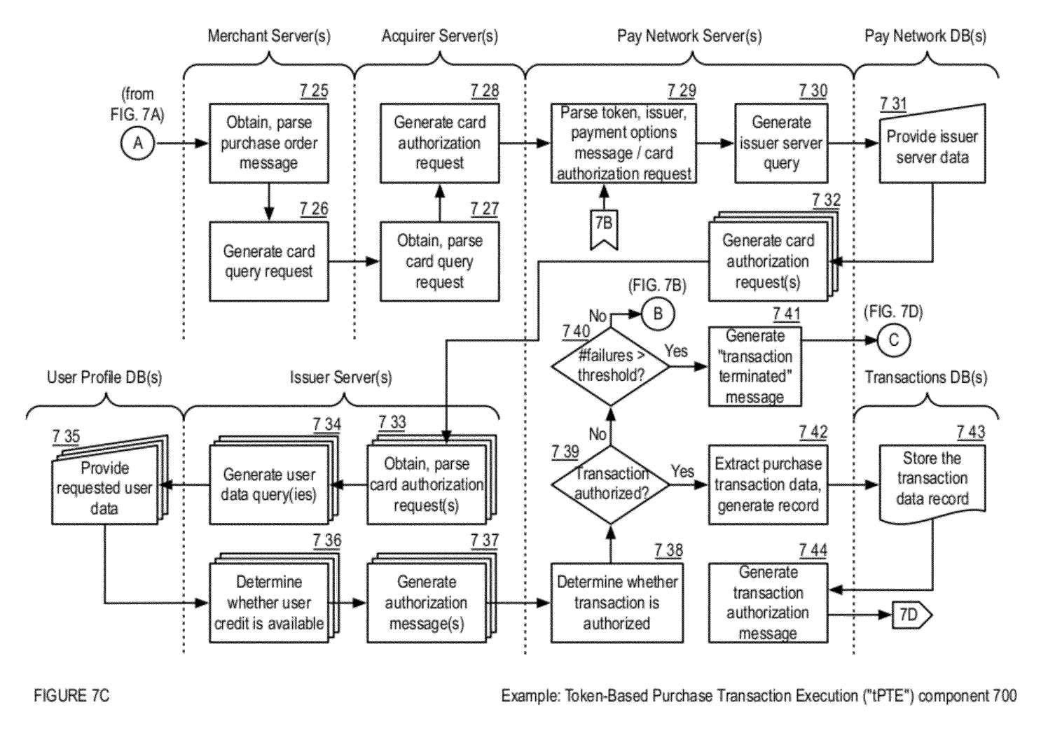

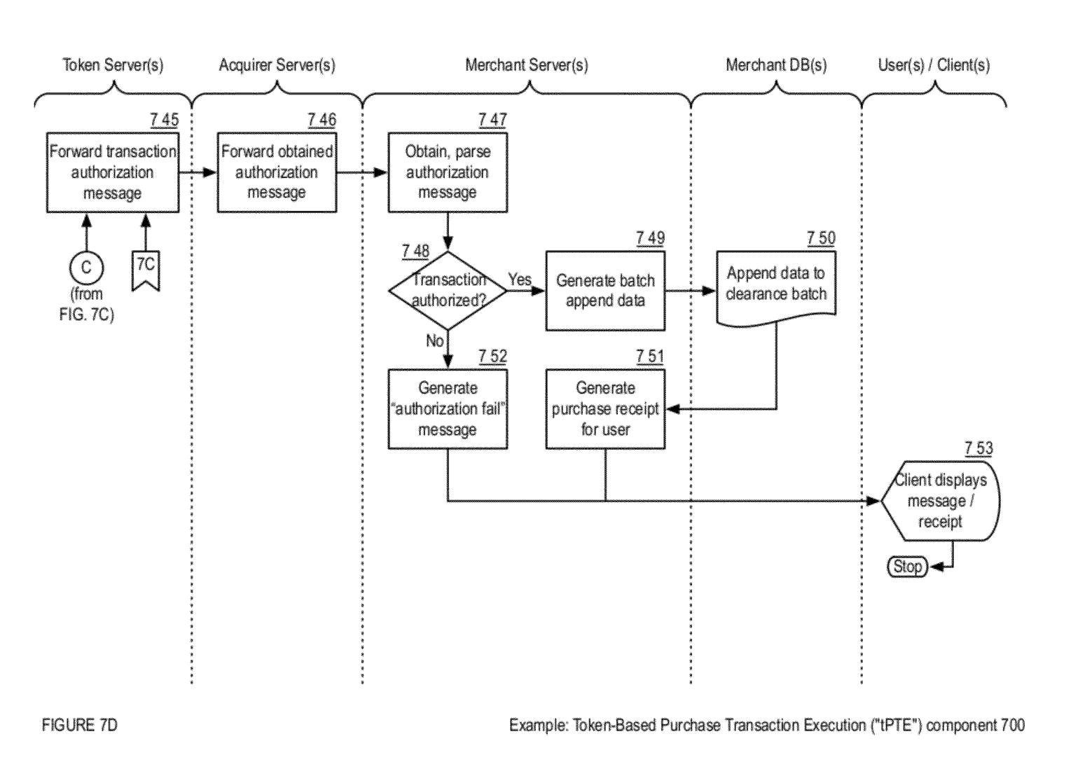

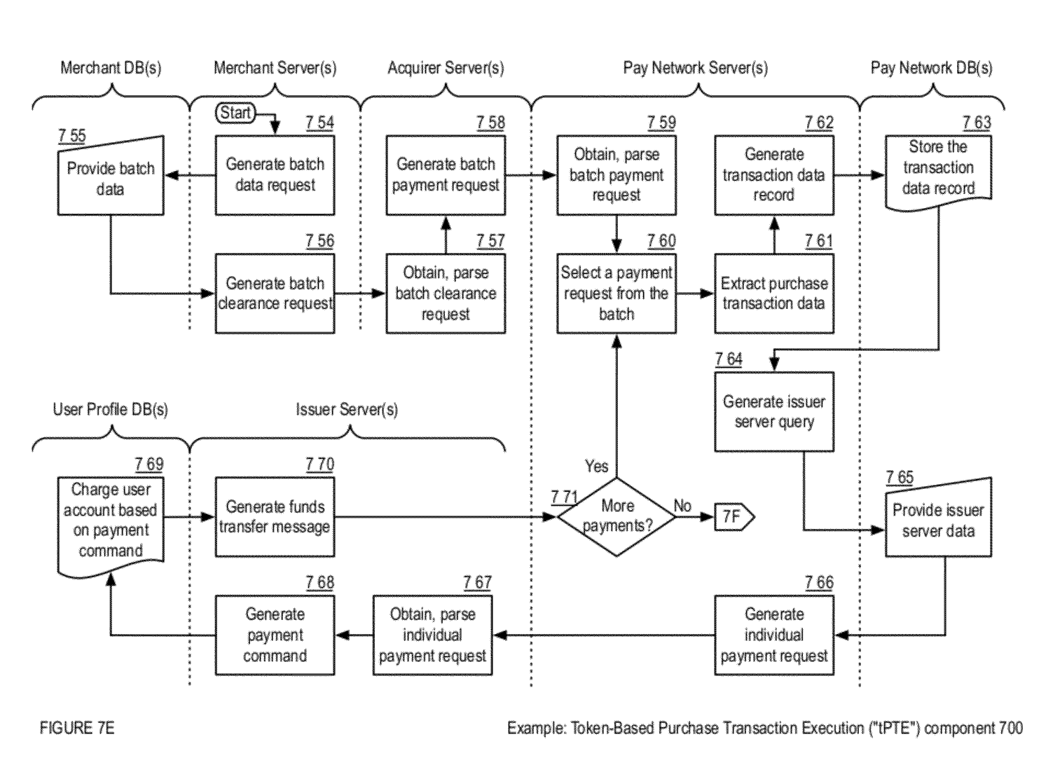

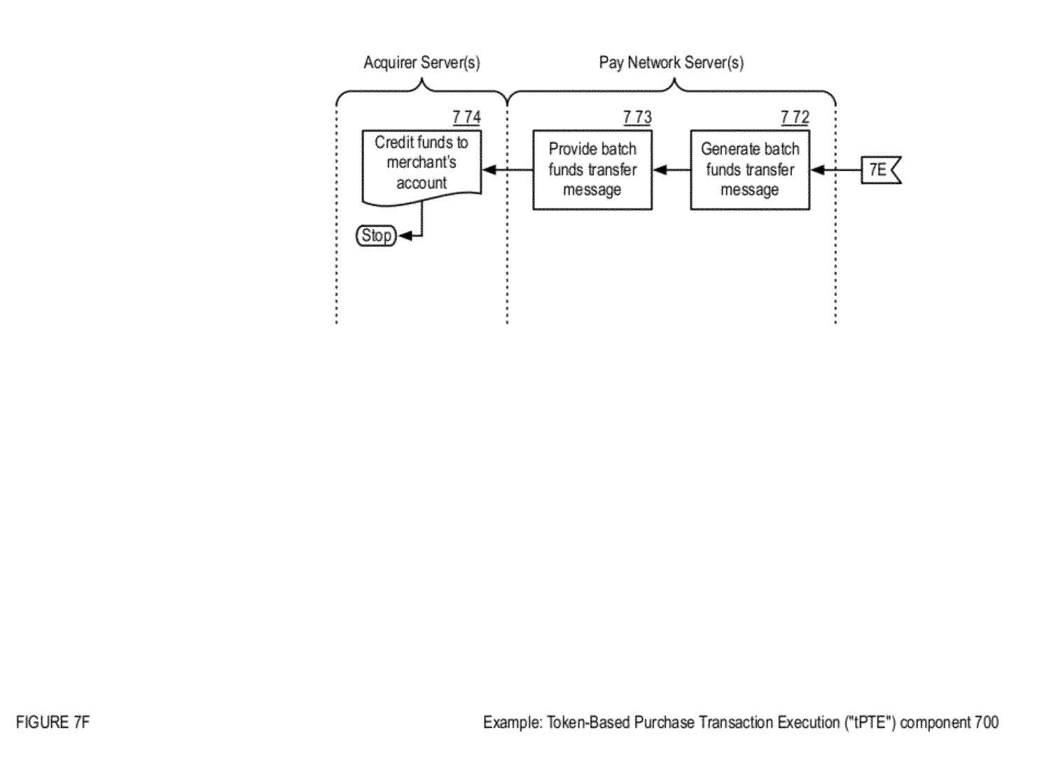

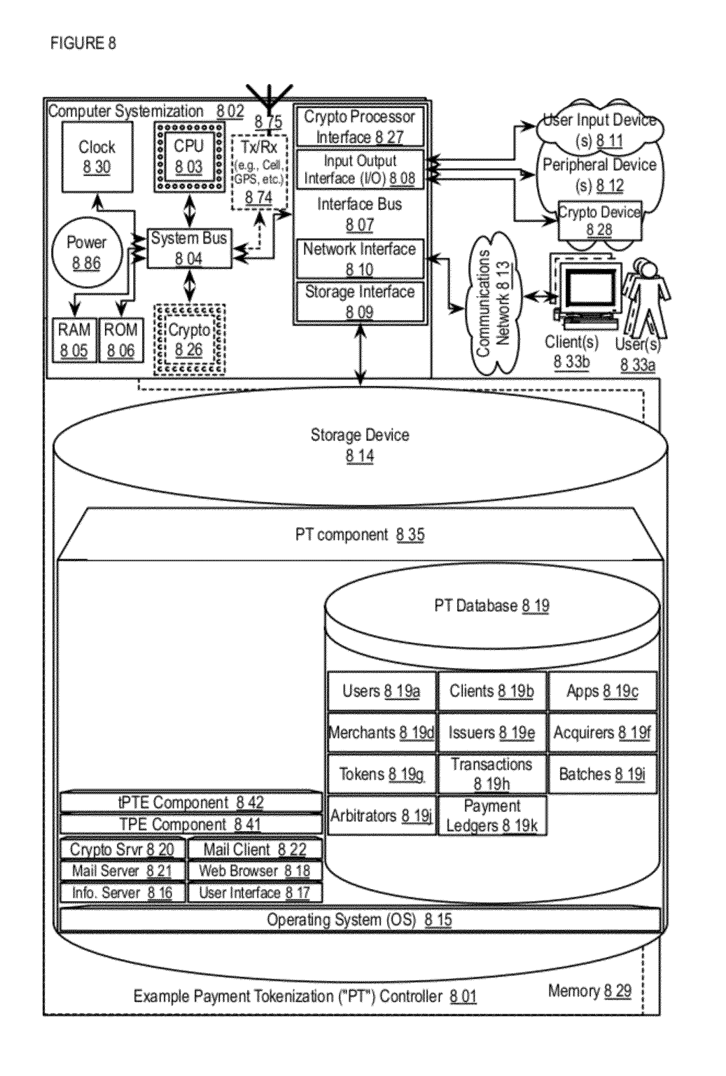

FIG. 5 shows a logic flow diagram illustrating example aspects of enrolling in a token-based purchase payment program in some embodiments of the PT, e.g., a Token-Based Purchase Enrollment (“TPE”) component 500. In some implementations, a user may desire to purchase a product, service, offering, and/or the like (“product”), from a merchant. The user may provide user input, e.g., purchase input 501, into the client indicating the user's desire to purchase the product. In some implementations, the client may generate a purchase order message, e.g., 502, and provide the generated purchase order message to the merchant server. The merchant server may obtain the purchase order message from the client, and may parse the purchase order message to extract details of the purchase order from the user, e.g., 503. For example, the merchant server may utilize parsers similar to the example parsers discussed below in the description with reference to FIG. 8. Based on the parsing, the merchant server may determine that the purchase order message is not tokenized, e.g., 504, option “No”. If the merchant server determines that the purchase order message is tokenization, the merchant server may invoke a procedure to process the transaction such as tPTE 700 component described further below in the discussion with reference to FIG. 7. Upon determining that the purchase order message is not tokenized, the merchant server may determine that the user needs to be provided with an option to sign up for payment tokenization services. The merchant server may attempt to identify a token arbitrator to provide the payment tokenization services for the user. For example, the merchant server may query, e.g., 505, a merchant database for an address of a token arbitrator. In response, the merchant database may provide the token arbitrator address, e.g., 506. The merchant server may generate a tokenization invitation request on behalf of the user, e.g., 507, and provide the tokenization invitation request to a token server.

In some implementations, the token server may parse the invitation request message, and extract details of the user and client from the message, e.g., 508. The token server may determine if additional information is required from the user to generate a token data structure and/or token data record, e.g., 509. If additional information is needed (e.g., not all fields of the token data record can be completed with the available information), the token server may generate a token input form, e.g., 511, and provide the token input form for the user. The token server may provide the token input form to the client (either directly to the client or via the merchant server). The client may render the form, and display, e.g., 512, the form for the user. In some implementations, the user may obtain a form such as the example user interface illustration depicted in FIG. 2B.

In some implementations, the user may desire to enroll for payment tokenization services, and may provide token creation input to complete the form, e.g., 513. The client may generate a competed form, and provide, e.g., 514, the form to the token server (either directly or via the merchant server). The token server may obtain the form, and parse the form to extract data fields and values from the form to generate a token data record, e.g., 515. For example, the token server may generate a unique and resolvable token identifier irrespective of the token requesting channel (e.g., merchant, issuer, acquirer, payment network, user, etc). In some implementations, the token server keeps track of all generated tokens via token identifiers, and as each is created, subsequent requests for creation of a token with the same token identifier will be denied. In some implementations, token record creation may be performed done serially. For example, a serial series of token identifiers may be created for each issuer, merchant, acquirer and/or payment network. For example, each series may involve a numeric range that is unique to each source. In other implementations, rather than serial application, token identifiers may be assigned by random allocation. In some implementations, each token may be pre-funded. For example, the source of the token (e.g., issuer, acquirer, independent token arbitrator) may first obtain assurance that funds have been uniquely and exclusively allocated for the token from the source to which the token points. Thus, in some implementations, the token may be pre-funded and pre-authorized for up to (or in the alternative, for exactly) a predefined amount of a purchase transaction. For example, the token server may generate a token data structure similar to the example XML-encoded data structure below:

<?XML version = “1.0” encoding = “UTF-8”?>
<token>

<unique_ID>4NFU4RG94</unique_ID>
<!-- user_ID may optionally be used in some embodiments-->
<user_ID>john.q.public@gmail.com</user_ID>
<timestamp>2011-02-22 15:22:43</timestamp>
<expiry>2011-02-28 23:59:59</expiry>
<auth_flag>true</auth_flag>
<auth_protocol>verifychat</auth_protocol>
<security_protocol>digital certificate, digital_cer_link
</security_protocol>
<digital_cert>52486ghb0bn_encrypted_hash_information_89032y4gh<digital_cert>
<digital_cert_link>http://www.acmedigitalcertification.com/auth.php?var=0t1h
v43059876</digital_cert_link>
<!-- In some embodiments, client_details are optional and the token may be
tied to a specific client-->
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>
<client_fingerprint>font list, MAC address, memory size, hardware

chip, screen resolution</client_fingerprint>
</client_details>
<funding>

<value_decay>10%/mo</value_decay>
<token_admin>issuer 123.65.78.129 123456789012345</token_admin>
<!--alternatively, token administrator may be different from funding

source and may also include merchant, pay network, third party-->

<funding_source>issuer</funding_source>
<!--merchant, pay networks, third parties pay also be funding

sources-->

<accounts>

<1>

<issuer_name>BankA</issuer_name>
<account_num>123456789012345</account_num>
<account_type>checking</account_type>
<confirm_type>email</confirm_type>
<!-- fields below optional in some embodiments-->
<account_name>John Q. Public</account_name>
<billing_addres>123 Green Street Apt 1</billing_address>
<phone>909-333-2345</phone>
<sign>/jqp/</sign>
<contact_info>jqp@gmail.com</contact_info>
<default_cost_share>65%</default_cost_share>

</1>
<2>

<issuer_name>TokenArbit</issuer_name>
<account_type>prefunded</account_type>
<unique_id>2325678654322345</unique_id>
<individual_decay>1.5%</individual_decay>
<default_cost_share>10%</default_cost_share>

</2>
<3>

<issuer_name>BankC</issuer_name>
<account_type>stored value account</account_type>
<account_num>123456789012345</account_num>
<max_value>$500</max_value>
<!-- fields below optional in some embodiments-->
<account_name>John Q. Public</account_name>
<billing_addres>123 Green Street Apt 1</billing_address>
<phone>909-333-2345</phone>
<sign>/jqp/</sign>
<confirm_type>email</confirm_type>
<contact_info>jqp@gmail.com</contact_info>
<default_cost_share>25%</default_cost_share>

</3>

</accounts>

</funding>
<shipping_info>

<unique_shipping_transaction_ID>A89349HH

</unique_shipping_transaction_ID>

<!-- use of shipping unique allows anonymous shipping to user in some

embodiments -->

<!-- fields below optional in some embodiments -->
<shipping_address>123 Green Street</shipping_address>
<ship_type>Overnight</ship_type>
<ship_carrier>FedEx</ship_carrier>
<ship_account>231453564392</ship_account>
<tracking_flag>true</tracking_flag>
<sign_flag>true</sign_flag>

</shipping_info>

</token>

The token server may store the token data structure to a token database, e.g., 516. The token server may also provide a token identifier, e.g., 517 to the client. The client may store the token identifier and/or display the token identifier for the user, e.g., 518.

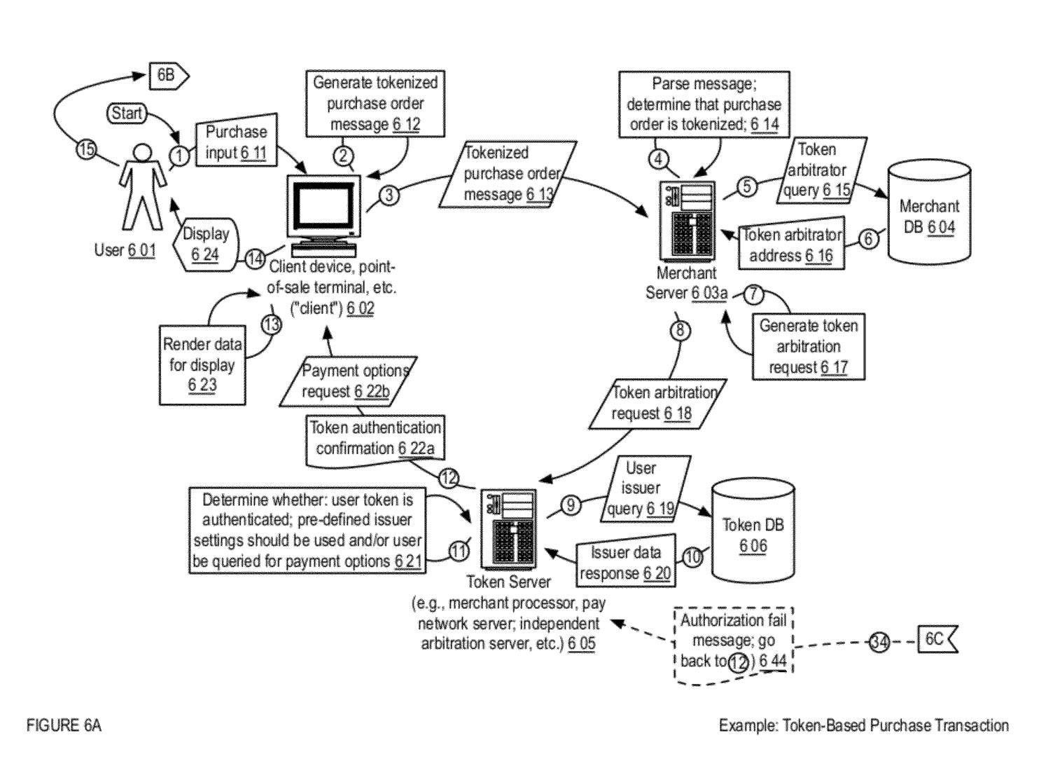

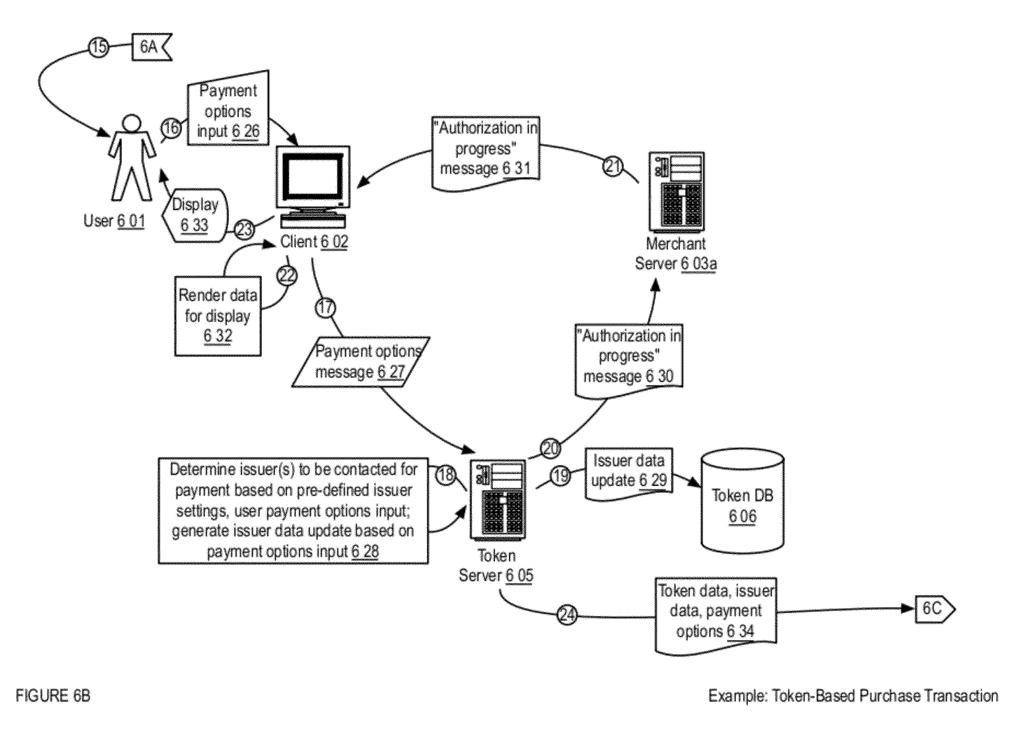

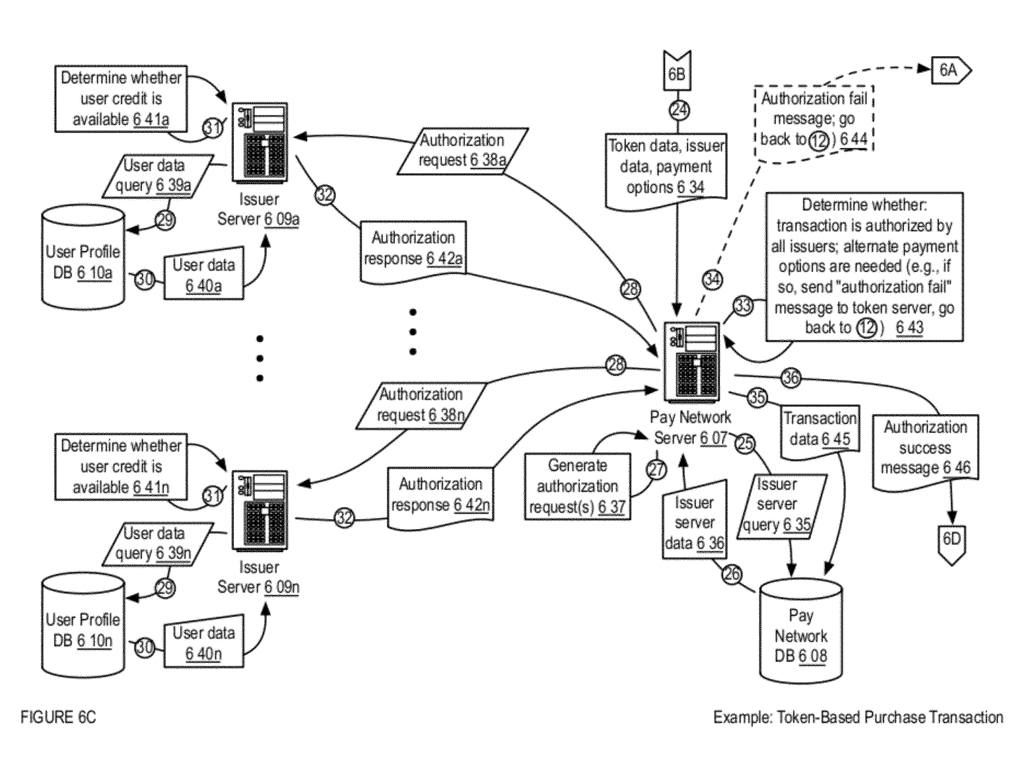

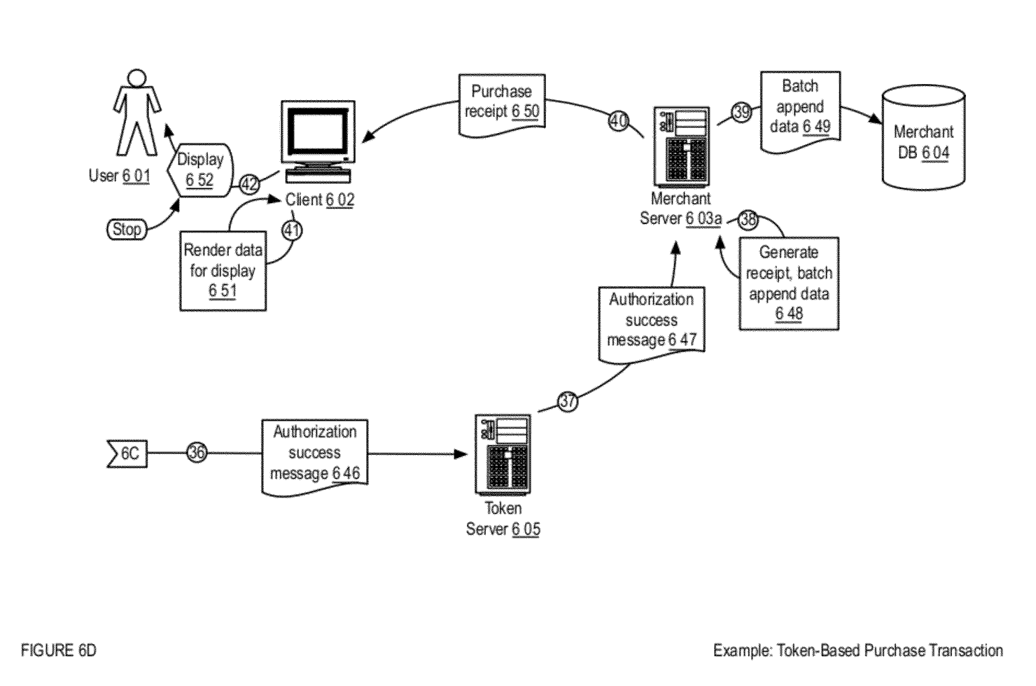

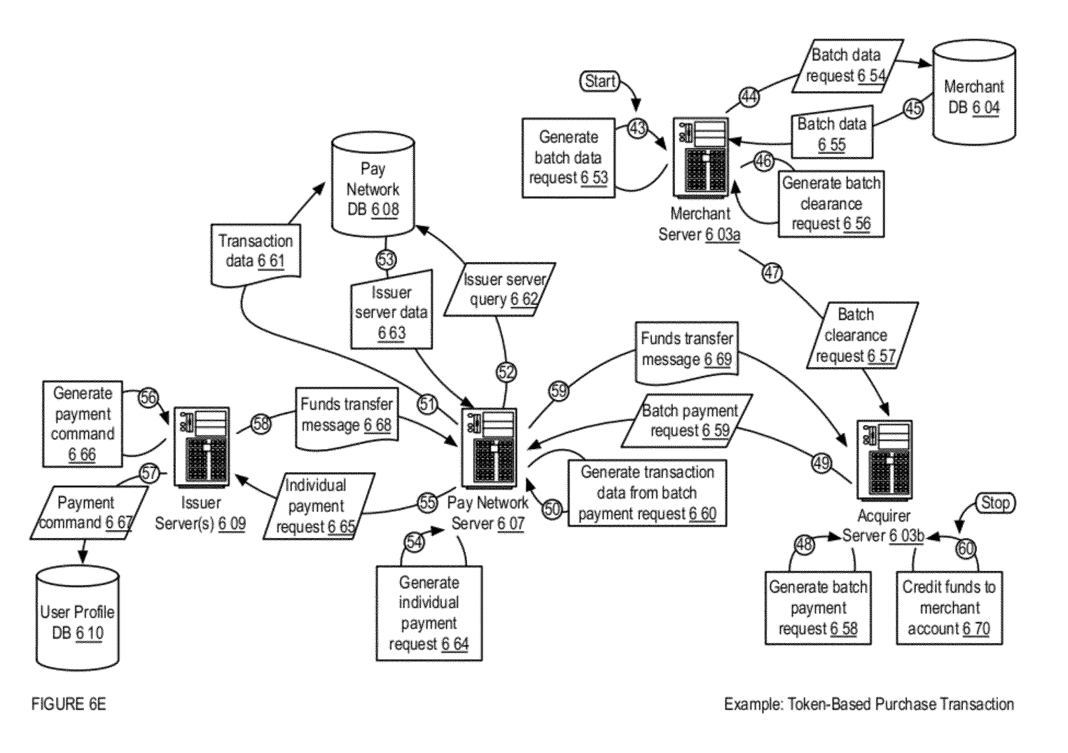

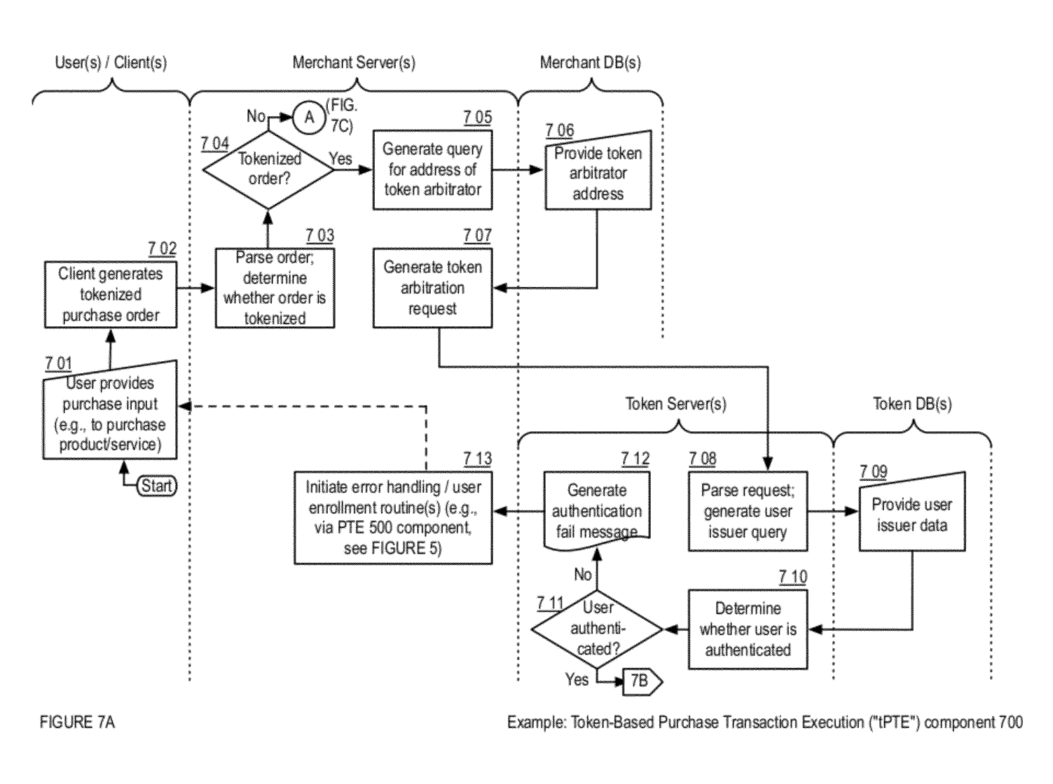

FIGS. 6A-E show data flow diagrams illustrating an example procedure to execute a token-based purchase transaction in some embodiments of the PT. In some implementations, a user, e.g., 601, may desire to purchase a product, service, offering, and/or the like (“product”), from a merchant. The user may communicate with a merchant server, e.g., 603a, via a client such as, but not limited to: a personal computer, mobile device, television, point-of-sale terminal, kiosk, ATM, and/or the like (e.g., 602). For example, the user may provide user input, e.g., purchase input 611, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, the client may generate a tokenized purchase order message, e.g., 612, and provide, e.g., 613, the tokenized purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<token_id>1234567890123456</token_id>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. Based on parsing the message, the merchant may determine that the purchase order is tokenized. The merchant server may issue a query to a database, e.g., 615, to a merchant database, e.g., 604, to determine an arbitrator to process the tokenized purchase order. For example, the merchant server may utilize a hypertext preprocessor (“PHP”) script including Structured Query Language (“SQL”) commands to query a relational database for an address of a token arbitrator. An example PHP/SQL listing for querying a database for a token arbitrator address is provided below:

<?PHP
header(′Content-Type: text/plain′);
mysql_connect(“254.93.179.112”,$DBserver,$password); // access
database server
mysql_select_db(“ARBITRATORS.SQL”); // select database table to
search
//create query for token arbitrators
$query = “SELECT arbitrator_id, arbitators_name arbitrator_address

arbitrator_URL FROM TokenizationTable WHERE user_card_num
LIKE ′%′ $userpaymentcardnumber”;

$result = mysql_query($query); // perform the search query
mysql_close(“ARBITRATORS.SQL”); // close database access
?>

In response, the merchant database may provide the token arbitrator address, e.g., 616. The merchant server may generate a token arbitration request, e.g., 617, and provide the token arbitration request, e.g., 618, to a token server, e.g., 605. For example, the merchant server may provide a HTTP(S) POST message including the token arbitration request similar to the example below:

POST /arbitrate.php HTTP/1.1
Host: www.tokenizer.com
Content-Type: Application/XML
Content-Length: 579
<?XML version = “1.0” encoding = “UTF-8”?>
GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<token_id>1234567890123456</token_id>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In various implementations, the token server may be part of the merchant system (e.g., a merchant process), or part of the payment network (e.g., a pay network server), or an independent server operating in conjunction with the merchant, issuer, acquirer and payment network. In general, it is to be understood that any entity and/or component included in the PT may serve as a token arbitrator. In some implementations, the token server may parse the token arbitration request message, and extract the payment token from the message. The token server may determine the payment options to utilize (or determine whether to request the user to provide payment options details) for processing the transaction, using the payment token. For example, the token server may issue, e.g., 619, a user issuer query to a database, e.g., token database 606, using the payment token as search term in the query. For example, the token server may utilize PHP/SQL commands similar to the examples described above. In response, the token database may provide an issuer data response, e.g., 620, including data on issuers to contact for payment. For example, the issuer data response may include an XML-encoded data file including instructions for the token server on how to proceed with payment processing for the transaction. An example XML-encoded issuer data file is provided below:

<?XML version = “1.0” encoding = “UTF-8”?>
<issuer_data>

<auto_default>false</auto_default>
<user_contact>in-app</user_contact>
<device_id>B17BP927</device_id>
<default>

<issuer>

<issuer_id>A12345</issuer_id>
<issuer_name>Bank de Tolkien</issuer_name>
<issuer_IP>123.45.67.891</issuer_IP>
<account_type>token</account_type>
<account_number>1234567890123456</account_number>
<percentage>65</percentage>

</issuer>
<issuer>

<issuer_id>B12345</issuer_id>
<issuer_name>ABC Credit Union</issuer_name>
<issuer_IP>223.25.67.091</issuer_IP>
<account_type>token</account_type>
<account_number>6543210987654321</account_number>
<percentage>25</percentage>

</issuer>
<issuer>

<issuer_id>C67890</issuer_id>
<issuer_name>BNR Bank</issuer_name>
<issuer_IP>153.65.87.231</issuer_IP>
<account_type>token</account_type>
<account_number>1234567890123456</account_number>
<percentage>10</percentage>

</issuer>

</default>

</issuer_data>

In some implementations, the token server may determine whether the user token is authenticated, e.g., 621. For example, if no XML data is available associated with the payment token, the token server may determine that the user has not signed up for payment tokenization services. As another example, if the XML data indicates that the user must be queried for authentication (e.g., login and password), then the token server may determine that verification of authentication is necessary. The token server may initiate a user verification session. For example, an app executing on the user's device may provide a “VerifyChat” feature for fraud prevention (e.g., by activating UI element 213 in FIG. 2). The token server may utilize the VerifyChat feature to communicate with the user, and verify the authenticity of the originator of the purchase transaction. In various implementations, the token server may send electronic mail message, text (SMS) messages, Facebook® messages, Twitter™ tweets, text chat, voice chat, video chat (e.g., Apple FaceTime), and/or the like to communicate with the user. For example, the token server may initiate a video challenge for the user. For example, the user may need to present him/her-self via a video chat. In some implementations, a customer service representative may manually determine the authenticity of the user using the video of the user. In some implementations, the PT may utilize face, biometric and/or like recognition (e.g., using pattern classification techniques) to determine the identity of the user. In some implementations, the app may provide reference marker (e.g., cross-hairs, target box, etc.), so that the user may the video to facilitate the PT′ automated recognition of the user. As another example, token server may request the user for a digital certificate to verify authenticity. As another example, the token server may request a user name and password to enable the token for payment processing.

If the token server determines that the user is authenticated, the token server may provide a token authentication confirmation, e.g., 622a. Also, if the token server determines that the user should be queried for payment options (e.g., instead of using only the pre-defined settings in the issuer data response 620), the token server may request payment options from the user. For example, the token server may provide a HTTP(S) POST message similar to the examples above to the client 602. The client may render, e.g., 623, the token authentication confirmation and/or payment options request, and display the message(s) for the user, e.g., 624.

In some implementations, the user may desire to enter custom payment options to process the current purchase transaction. In such implementations, the user may provide a payment options input 626, for example, such as discussed above in the description with reference to FIG. 2. The client may generate a payment options message using the user's input, and provide the payment options message, e.g., 627, to the token server. In some implementations, the token server may determine the issuers to contact for payment processing using the pre-defined issuer settings and/or the payment options input provided by the user, e.g., 628. In some implementations, the token server may update the issuer data stored in the token database using the payment options input provided by the user, e.g., 629.

In some implementations, the token server may provide the token data, issuer data, and/or user payment options input, e.g., 634, to a pay network server (e.g., if the token server is separate from the pay network system). For example, the token server may provide a HTTP(S) POST message to the pay network server similar to the examples above. The pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some implementations, the pay network server may generate a query, e.g., 635, for issuer server(s) corresponding to the payment token and user-selected payment options. For example, the user's payment token may be linked to one or more issuer financial institutions (“issuers”), such as banking institutions, which issued the account(s) for the user linked to the payment token. For example, such accounts may include, but not be limited to: credit card, debit card, prepaid card, checking, savings, money market, certificates of deposit, stored (cash) value accounts and/or the like. Issuer server(s), e.g., 609a-n, of the issuer(s) may maintain details of the user's account linked to the payment token. In some implementations, a database, e.g., pay network database 608, may store details of the issuer server(s) associated with the issuer(s). For example, the database may be a relational database responsive to Structured Query Language (“SQL”) commands. The pay network server may query the pay network database for issuer server(s) details. For example, the pay network server may execute a hypertext preprocessor (“PHP”) script including SQL commands to query the database for details of the issuer server(s). An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address

mac_address auth_key port_num security_settings_list FROM
IssuerTable WHERE account_num LIKE ′%′ $accountnum”;

$result = mysql_query($query); // perform the search query
mysql_close(“ISSUERS.SQL”); // close database access
?>

In response to obtaining the issuer server query, e.g., 635, the pay network database may provide, e.g., 636, the requested issuer server data to the pay network server. In some implementations, the pay network server may utilize the issuer server data to generate authorization request(s), e.g., 637, for each of the issuer server(s) selected based on the pre-defined payment settings associated with the token, and/or the user's payment options input, and provide the card authorization request(s), e.g., 638a-n, to the issuer server(s), e.g., 609a-n. In some implementations, the authorization request(s) may include details such as, but not limited to: the costs to the user involved in the transaction, card account details of the user, user billing and/or shipping information, and/or the like. For example, the pay network server may provide a HTTP(S) POST message including an XML-formatted authorization request similar to the example listing provided below:

POST /authorization.php HTTP/1.1
Host: www.issuer.com
Content-Type: Application/XML
Content-Length: 624
<?XML version = “1.0” encoding = “UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for dummies</product_summary>
<product_quantity>1</product_quantity?

</product>

</purchase_summary>
<transaction_cost>$22.61</transaction_cost>
<account_params>

<account_type>token</account_type>
<account_num>1234567890123456</account_num>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</card_query_request>

In some implementations, an issuer server may parse the authorization request(s), and based on the request details may query a database, e.g., user profile database 610a-n, for data associated with an account linked to the user's payment token. For example, the issuer server may issue PHP/SQL commands similar to the example provided below:

<?PHP
header(′Content-Type: text/plain′);
mysql_connect(“254.93.179.112”,$DBserver,$password); // access
database server
mysql_select_db(“USERS.SQL”); // select database table to search
//create query for user data
$query = “SELECT user_id user_name user_balance account_type

FROM UserTable WHERE account_num LIKE ′%′ $accountnum”;

$result = mysql_query($query); // perform the search query
mysql_close(“USERS.SQL“); // close database access
?>

In some implementations, on obtaining the user data, e.g., 640a-n, the issuer server may determine whether the user can pay for the transaction using funds available in the account, e.g., 641a-n. For example, the issuer server may determine whether the user has a sufficient balance remaining in the account, sufficient credit associated with the account, and/or the like. Based on the determination, the issuer server(s) may provide an authorization response, e.g., 642a-n, to the pay network server. For example, the issuer server(s) may provide a HTTP(S) POST message similar to the examples above. In some implementations, if at least one issuer server determines that the user cannot pay for the transaction using the funds available in the account, see e.g., 643-644, the pay network server may request payment options again from the user (e.g., by providing an authorization fail message 644 to the token server and requesting the token server to obtain payment options input again from the user), and re-attempt authorization for the purchase transaction. In some implementations, if the number of failed authorization attempts exceeds a threshold, the pay network server may abort the authorization process, and provide an “authorization fail” message to the merchant server, token server and/or client.

In some implementations, the pay network server may obtain the authorization message including a notification of successful authorization, see e.g., 643, 646, and parse the message to extract authorization details. Upon determining that the user possesses sufficient funds for the transaction, the pay network server may generate a transaction data record, e.g., 645, from the authorization request and/or authorization response, and store the details of the transaction and authorization relating to the transaction in a transactions database. For example, the pay network server may issue PHP/SQL commands similar to the example listing below to store the transaction data in a database:

<?PHP
header(′Content-Type: text/plain′);
mysql_connect(″254.92.185.103”,$DBserver,$password); // access
database server
mysql_select(″TRANSACTIONS.SQL″); // select database to append
mysql_query(“INSERT INTO PurchasesTable (timestamp,

purchase_summary_list, num_products, product_summary,
product_quantity, transaction_cost, account_params_list,
account_name, account_type, account_num, billing_addres,
zipcode, phone, sign, merchant_params_list, merchant_id,
merchant_name, merchant_auth_key)

VALUES (time( ), $purchase_summary_list, $num_products,

$product_summary, $product_quantity, $transaction_cost,
$account_params_list, $account_name, $account_type,
$account_num, $billing_addres, $zipcode, $phone, $sign,
$merchant_params_list, $merchant_id, $merchant_name,
$merchant_auth_key)”);
// add data to table in database

mysql_close(″TRANSACTIONS.SQL″); // close connection to database
?>

In some implementations, the pay network server may forward an authorization success message, e.g., 646, to the token server, which may in turn forward the authorization success message, e.g., 647, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 648, and store the XML data file, e.g., 649, in a database, e.g., merchant database 604. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_key>
<account_number>123456789</account_number>

</merchant_data>
<transaction_data>

<transaction 1>

. . .

</transaction 1>
<transaction 2>

. . .

</transaction 2>

.
.
.

<transaction n>

. . .

</transaction n>

</transaction_data>

In some implementations, the server may also generate a purchase receipt, e.g., 648, and provide the purchase receipt to the client, e.g., 650. The client may render and display, e.g., 651-652, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 6E, in some implementations, the merchant server may initiate clearance of a batch of authorized transactions. For example, the merchant server may generate a batch data request, e.g., 653, and provide the request, e.g., 654, to a database, e.g., merchant database 604. For example, the merchant server may utilize PHP/SQL commands similar to the examples provided above to query a relational database. In response to the batch data request, the database may provide the requested batch data, e.g., 655. The server may generate a batch clearance request, e.g., 656, using the batch data obtained from the database, and provide, e.g., 657, the batch clearance request to an acquirer server, e.g., 603b. For example, the merchant server may provide a HTTP(S) POST message including XML-formatted batch data in the message body for the acquirer server. The acquirer server may generate, e.g., 658, a batch payment request using the obtained batch clearance request, and provide the batch payment request to the pay network server, e.g., 659. The pay network server may parse the batch payment request, and extract the transaction data for each transaction stored in the batch payment request, e.g., 660. The pay network server may store the transaction data, e.g., 661, for each transaction in a database, e.g., pay network database 608. For each extracted transaction, the pay network server may query, e.g., 662-663, a database, e.g., pay network database 608, for an address of an issuer server. For example, the pay network server may utilize PHP/SQL commands similar to the examples provided above. The pay network server may generate an individual payment request, e.g., 664, for each transaction for which it has extracted transaction data, and provide the individual payment request, e.g., 665, to the issuer server, e.g., 609. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_summary>

<num_products>1</num_products>
<product>

<product_summary>Book - XML for dummies</product_summary>
<product_quantity>1</product_quantity?

</product>

</purchase_summary>

</pay_request>

In some implementations, the issuer server may generate a payment command, e.g., 666. For example, the issuer server may issue a command to deduct funds from the user's account (or add a charge to the user's credit card account). The issuer server may issue a payment command, e.g., 667, to a database storing the user's account information, e.g., user profile database 610. The issuer server may provide a funds transfer message, e.g., 668, to the pay network server, which may forward, e.g., 669, the funds transfer message to the acquirer server. An example HTTP(S) POST funds transfer message is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 670.

FIGS. 7A-F show logic flow diagrams illustrating example aspects of executing a token-based purchase transaction in some embodiments of the PT, e.g., a Token-Based Purchase Transaction Execution (“tPTE”) component 700. In some implementations, a user may desire to purchase a product, service, offering, and/or the like (“product”), from a merchant. The user may communicate with a merchant server, via a client. For example, the user may provide purchase input, e.g., 701, into the client indicating the user's desire to purchase the product. In some implementations, the client may generate a tokenized purchase order message, e.g., 702, and provide the tokenized purchase order message to the merchant server. The merchant server may obtain the purchase order message from the client, and may parse the purchase order message to extract details of the purchase order from the user. Based on parsing the message, the merchant may determine that the purchase order is tokenized, e.g., 703. If the merchant server determines that the purchase order is not tokenized, e.g., 704, option “No,” then the merchant server may process the transaction as a normal card-based transaction, and bypass the token interpretation process. If the merchant server determines that the purchase order is tokenized, e.g., 704, option “Yes,” then the merchant server may issue a query, e.g., 705, to a merchant database to determine an arbitrator to process the tokenized purchase order. In response, the merchant database may provide the token arbitrator address, e.g., 707. The merchant server may generate a token arbitration request, e.g., 708, and provide the token arbitration request to a token server.

In some implementations, the token server may parse the token arbitration request message, and extract the payment token from the message. The token server may determine the payment options to utilize (or determine whether to request the user to provide payment options details) for processing the transaction, using the payment token. For example, the token server may issue, e.g., 708, a user issuer query to a token database using the payment token as search term in the query. In response, the token database may provide an issuer data response, e.g., 709, including data on issuers to contact for payment. In some implementations, the token server may determine whether the user token is authenticated, e.g., 710. If the token server determines that the user is not authenticated, e.g., 711, option “No,” the token server may generate an “authentication fail message,” e.g., 712, and initiate an error-handling routine and/or a user enrollment routine, e.g., 713, such as the PTE 500 component discussed above in the description with reference to FIG. 5. If the token server determines that the user is authenticated, e.g., 711, option “Yes,” the token server may determine whether the user should be queried for payment options (e.g., instead of using only the pre-defined settings in the issuer data response), e.g., 714. If the token server determines that the user should be queries for payment options settings, e.g., 715, option “No,” the token server may request payment options from the user, e.g., 716. The client may render the payment options request and display the request, e.g., 717.

In some implementations, the user may desire to enter custom payment options to process the current purchase transaction. In such implementations, the user may provide a payment options input 718. The client may generate a payment options message using the user's input, and provide the payment options message to the token server. In some implementations, the token server may determine the issuers to contact for payment processing using the pre-defined issuer settings and/or the payment options input provided by the user, e.g., 719. In some implementations, the token server may update the issuer data stored in the token database using the payment options input provided by the user, e.g., 720. In some implementations, the token server may generate an “authorization in progress” message, e.g., 721, and provide the message to the merchant server, which may in turn forward, e.g., 722, the message to the client. The client may render and display, e.g., 723, the “authorization in progress” message for the user.

In some implementations, the token server may generate a message including the token data, issuer data, and/or user payment options input, e.g., 724, and provide the message to a pay network server (e.g., if the token server is separate from the pay network system). The pay network server may process the transaction so as to transfer funds for the purchase into an account stored on an acquirer of the merchant. If the merchant server initially received a non-tokenized purchase order message for the client, e.g., 725, the merchant server may generate a card query request, e.g., 726, and provide the card query request to an acquirer server. The acquirer server may parse the merchant server's request, e.g., 727, generate a card authorization request, e.g., 728, and provide the card authorization request to a pay network server. However, if the initial purchase order from the client is tokenized, the token server may deconstruct the payment details to be utilized, as discussed above, and may provide the token, issue and payment options to a pay network server, e.g., 729.

In some implementations, the pay network server may generate a query, e.g., 729, for issuer server(s) corresponding to the payment token and user-selected payment options. In some implementations, the pay network server may query the pay network database for issuer server(s) details, e.g., 730. In response to obtaining the issuer server query, the pay network database may provide, e.g., 731, the requested issuer server data to the pay network server. In some implementations, the pay network server may utilize the issuer server data to generate authorization request(s), e.g., 732, for each of the issuer server(s) selected based on the pre-defined payment settings associated with the token, and/or the user's payment options input, and provide the card authorization request(s) to the issuer server(s). In some implementations, an issuer server may parse the authorization request(s), e.g., 733, and based on the request details may query a user profile database for data associated with an account linked to the user's payment token, e.g., 734. In some implementations, on obtaining the user data, e.g., 735, the issuer server may determine whether the user can pay for the transaction using funds available in the account, e.g., 736. For example, the issuer server may determine whether the user has a sufficient balance remaining in the account, sufficient credit associated with the account, and/or the like. Based on the determination, the issuer server(s) may generate and provide an authorization response, e.g., 737, to the pay network server. In some implementations, if at least one issuer server determines that the user cannot pay for the transaction using the funds available in the account, see e.g., 738, 739, option “No,” the pay network server may request payment options again from the user (e.g., by providing an authorization fail message 644 to the token server and requesting the token server to obtain payment options input again from the user), and re-attempt authorization for the purchase transaction. In some implementations, if the number of failed authorization attempts exceeds a threshold, e.g., 740, option “Yes,” the pay network server may abort the authorization process, and provide an “transaction terminated” message, e.g., 741, to the merchant server, token server and/or client.

In some implementations, the pay network server may obtain the authorization message including a notification of successful authorization and parse the message to extract authorization details. Upon determining that the user possesses sufficient funds for the transaction, e.g., 739, option “Yes,” the pay network server may generate a transaction data record, e.g., 742, from the authorization request and/or authorization response, and store, e.g., 743, the details of the transaction and authorization relating to the transaction in a transactions database. In some implementations, the pay network server may generate an authorization success message, e.g., 744, and forward the message to the token server, which may in turn forward the authorization success message, e.g., 745-746, to the acquirer server and/or the merchant server. In some embodiments, the authorization success message may include no personally identifying information, and may, in some embodiments, include only the payment token identifier. The merchant may obtain the authorization message, and determine from it whether the transaction was authorized, e.g., 747-748. If the transaction was authorized, e.g., 748, option “Yes,” the merchant server may add a record of the transaction for the user to a batch of transaction data relating to authorized transactions, e.g., 749-750. In some implementations, the server may also generate a purchase receipt, e.g., 751, and provide the purchase receipt to the client. The client may render and display, e.g., 753, the purchase receipt for the user.

With reference to FIGS. 7E-F, in some implementations, the merchant server may initiate clearance of a batch of authorized transactions. For example, the merchant server may generate a batch data request, e.g., 754, and provide the request to a merchant database. In response to the batch data request, the merchant database may provide the requested batch data, e.g., 755. The server may generate a batch clearance request, e.g., 756, using the batch data obtained from the database, and provide the batch clearance request to an acquirer server. The acquirer server may parse the batch clearance request, e.g., 657, and generate, e.g., 758, a batch payment request using the obtained batch clearance request, and provide the batch payment request to the pay network server. The pay network server may parse the batch payment request, e.g., 759, and extract the transaction data for each transaction stored in the batch payment request. For each payment request in the batch, the pay network server may extract purchase transaction data, e.g., 761, and generate a transaction data record, e.g., 762. The pay network server may store the transaction data, e.g., 763, for each transaction in a pay network database. For each extracted transaction, the pay network server may query, e.g., 764-765, the pay network database for an address of an issuer server. The pay network server may generate an individual payment request, e.g., 766, for each transaction for which it has extracted transaction data, and provide the individual payment request to the issuer server.

In some implementations, the issuer server may parse the individual payment request, e.g., 767, and generate a payment command, e.g., 768. For example, the issuer server may issue a command to deduct funds from the user's account (or add a charge to the user's credit card account). The issuer server may issue a payment command to a user profile database. The issuer server may generate a funds transfer message, e.g., 770, and provide the message to the pay network server. As described above, the system may process each individual payment request in the batch, until all requests in the batch have been processed, see e.g., 771. The pay network server may then generate a batch funds transfer message, e.g., 772, and provide the batch funds transfer message to the acquirer server, e.g., 773. In some implementations, the acquirer server may parse the funds transfer message, and correlate the transaction to the merchant. The acquirer server may then transfer the funds specified in the funds transfer message to an account of the merchant, e.g., 774.

### PT Controller

FIG. 8 illustrates inventive aspects of a PT controller 801 in a block diagram. In this embodiment, the PT controller 801 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the PT controller 801 may be connected to and/or communicate with entities such as, but not limited to: one or more users from user input devices 811; peripheral devices 812; an optional cryptographic processor device 828; and/or a communications network 813. For example, the PT controller 801 may be connected to and/or communicate with users operating client device(s) including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The PT controller 801 may be based on computer systems that may comprise, but are not limited to, components such as: a computer systemization 802 connected to memory 829.

### Computer Systemization

A computer systemization 802 may comprise a clock 830, central processing unit (“CPU(s)” and/or “processor(s)” (these terms are used interchangeable throughout the disclosure unless noted to the contrary)) 803, a memory 829 (e.g., a read only memory (ROM) 806, a random access memory (RAM) 805, etc.), and/or an interface bus 807, and most frequently, although not necessarily, are all interconnected and/or communicating through a system bus 804 on one or more (mother)board(s) 802 having conductive and/or otherwise transportive circuit pathways through which instructions (e.g., binary encoded signals) may travel to effect communications, operations, storage, etc. Optionally, the computer systemization may be connected to an internal power source 886; e.g., optionally the power source may be internal. Optionally, a cryptographic processor 826 and/or transceivers (e.g., ICs) 874 may be connected to the system bus. In another embodiment, the cryptographic processor and/or transceivers may be connected as either internal and/or external peripheral devices 812 via the interface bus I/O. In turn, the transceivers may be connected to antenna(s) 875, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing PT controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the PT controller and beyond through various interfaces. Should processing requirements dictate a greater amount speed and/or capacity, distributed processors (e.g., Distributed PT), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the PT may be achieved by implementing a microcontroller such as CAST's R8051XC2 microcontroller; Intel's MCS 51 (i.e., 8051 microcontroller); and/or the like. Also, to implement certain features of the PT, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the PT component collection (distributed or otherwise) and/or features may be implemented via the microprocessor and/or via embedded components; e.g., via ASIC, coprocessor, DSP, FPGA, and/or the like. Alternately, some implementations of the PT may be implemented with embedded components that are configured and used to achieve a variety of features or signal processing.

Depending on the particular implementation, the embedded components may include software solutions, hardware solutions, and/or some combination of both hardware/software solutions. For example, PT features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the PT features. A hierarchy of programmable interconnects allow logic blocks to be interconnected as needed by the PT system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the PT may be developed on regular FPGAs and then migrated into a fixed version that more resembles ASIC implementations. Alternate or coordinating implementations may migrate PT controller features to a final ASIC instead of or in addition to FPGAs. Depending on the implementation all of the aforementioned embedded components and microprocessors may be considered the “CPU” and/or “processor” for the PT.

### Power Source

The power source 886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the PT thereby providing an electric current to all subsequent components. In one example, the power source 886 is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

### Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Through a communications network 813, the PT controller is accessible through remote clients 833b (e.g., computers with web browsers) by users 833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed PT), architectures may similarly be employed to pool, load balance, and/or otherwise increase the communicative bandwidth required by the PT controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user input devices 811, peripheral devices 812, cryptographic processor devices 828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 811 often are a type of peripheral device 812 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 812 may be connected and/or communicate to I/O and/or other facilities of the like such as network interfaces, storage interfaces, directly to the interface bus, system bus, the CPU, and/or the like. Peripheral devices may be external, internal and/or part of the PT controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 828), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the PT controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the PT controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that the PT controller and/or a computer systemization may employ various forms of memory 829. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 829 will include ROM 806, RAM 805, and a storage device 814. A storage device 814 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 829 may contain a collection of program and/or database components and/or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the PT component(s) 835; and/or the like (i.e., collectively a component collection). These components may be stored and accessed from the storage devices and/or from storage devices accessible through an interface bus. Although non-conventional program components such as those in the component collection, typically, are stored in a local storage device 814, they may also be loaded and/or stored in memory such as: peripheral devices, RAM, remote storage facilities through a communications network, ROM, various forms of memory, and/or the like.

### Operating System

The operating system component 815 is an executable program component facilitating the operation of the PT controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the PT controller to communicate with other entities through a communications network 813. Various communication protocols may be used by the PT controller as a subcarrier transport mechanism for interaction, such as, but not limited to: multicast, TCP/IP, UDP, unicast, and/or the like.

### Information Server

An information server component 816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the PT controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the PT database 819, operating systems, other program components, user interfaces, Web browsers, and/or the like.

Access to the PT database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the PT. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the PT as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/2 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the PT enabled nodes. The combined application may be nugatory on systems employing standard Web browsers.

### Mail Server

A mail server component 821 is a stored program component that is executed by a CPU 803. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the PT.

Access to the PT mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 822 is a stored program component that is executed by a CPU 803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 820 is a stored program component that is executed by a CPU 803, cryptographic processor 826, cryptographic processor interface 827, cryptographic processor device 828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the PT may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the PT component to engage in secure transactions if so desired. The cryptographic component facilitates the secure accessing of resources on the PT and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The PT Database

The PT database component 819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the PT database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the PT database is implemented as a data-structure, the use of the PT database 819 may be integrated into another component such as the PT component 835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 819 includes several tables 819a-k. A Users table 819a may include fields such as, but not limited to: user_id, ssn, dob, first_name, last_name, age, state, address_firstline, address_secondline, zipcode, devices_list, contact_info, contact_type, alt contact_info, alt contact_type, and/or the like. The Users table may support and/or track multiple entity accounts on a PT. A Clients table 819b may include fields such as, but not limited to: user_id, client_id, client_ip, client_type, client_model, operating_system, os_version, app_installed_flag, and/or the like. An Apps table 819c may include fields such as, but not limited to: app_ID, app_name, app_type, OS_compatibilities_list, version, timestamp, developer_ID, and/or the like. A Merchants table 819d may include fields such as, but not limited to: merchant_id, merchant_name, provi merchant_address, ip_address, mac_address, auth_key, port_num, security_settings_list, and/or the like. An Issuers table 819e may include fields such as, but not limited to: issuer_id, issuer_name, issuer_address, ip_address, mac_address, auth_key, port_num, security_settings_list, and/or the like. An Acquirers table 819f may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Tokens table 819g may include fields such as, but not limited to: token_id, token_phrase, token_issuer, token_md5, token_security, user_id, password, token_composition_list, account_link, and/or the like. A Transactions table 819h may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 819i may include fields such as, but not limited to: batch_id, transaction_id_list, timestamp_list, cleared_flag_list, clearance_trigger settings, and/or the like. An Arbitrators table 819j may include fields such as, but not limited to: arbitrator_id, arbitrator_name, arbitrator_geo, arbitrator_IP, arbitrator_URL, merchant_service_list, and/or the like. A Payment Ledgers table 819k may include fields such as, but not limited to: request_id, timestamp, deposit_amount, batch_id, transaction_id, clear_flag, deposit_account, transaction_summary, payor_name, payor_account, and/or the like.

In one embodiment, the PT database may interact with other database systems. For example, employing a distributed database system, queries and data access by search PT component may treat the combination of the PT database, an integrated data security layer database as a single database entity.

In one embodiment, user programs may contain various user interface primitives, which may serve to update the PT. Also, various accounts may require custom database tables depending upon the environments and the types of clients the PT may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 819a-k. The PT may be configured to keep track of various settings, inputs, and parameters via database controllers.

The PT database may communicate to and/or with other components in a component collection, including itself, and/or facilities of the like. Most frequently, the PT database communicates with the PT component, other program components, and/or the like. The database may contain, retain, and provide information regarding other nodes and data.

### The PTs

The PT component 835 is a stored program component that is executed by a CPU. In one embodiment, the PT component incorporates any and/or all combinations of the aspects of the PT discussed in the previous figures. As such, the PT affects accessing, obtaining and the provision of information, services, transactions, and/or the like across various communications networks.

The PT component may transform payment token-based purchase orders via PT components into multi-issuer purchase payment funds transfers, and/or the like and use of the PT. In one embodiment, the PT component 835 takes inputs (e.g., purchase input 411, token arbitrator address 416, token creation input 423, purchase input 611, token arbitrator address 616, issuer data response 620, payment option input 626, issuer server data 636, user data 640a-n, batch data 655, issuer server data 663, and/or the like) etc., and transforms the inputs via various components (e.g., TPE 841, tPTE 842, and/or the like), into outputs (e.g., tokenization invitation 420, token data 426, token authentication confirmation 622a, issuer data update 629, “authorization in progress” message 630-31, token data 634, authorization fail message 644, transaction data 645, authorization response 642a-n, authorization success message 646-47, batch append data 649, purchase receipt 650, transaction data 661, funds transfer message 668-69, and/or the like).

The PT component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the PT server employs a cryptographic server to encrypt and decrypt communications. The PT component may communicate to and/or with other components in a component collection, including itself, and/or facilities of the like. Most frequently, the PT component communicates with the PT database, operating systems, other program components, and/or the like. The PT may contain, communicate, generate, obtain, and/or provide program component, system, user, and/or data communications, requests, and/or responses.

### Distributed PTs

The structure and/or operation of any of the PT node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the PT controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3c -post http://... Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the PT controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock) ;
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm

.IBMDI.doc/referenceguide295.htm

and other parser implementations:

http://publib.boulder.ibm.com/infocenter/tivihelp/v2r1/index.jsp?topic=/com.ibm

.IBMDI.doc/referenceguide259.htm

all of which are hereby expressly incorporated by reference.

Non-limiting exemplary embodiments highlighting numerous further advantageous aspects include:

A1. A payment tokenization enrollment processor-implemented method embodiment, comprising:
obtaining a purchase order from a client device of a user;
extracting purchase payment information from the purchase order message;
determining via a processor that the user is not enrolled for payment tokenization services based on the purchase payment information;
generating a tokenization invitation request; and
providing the tokenization invitation request to a token arbitration server.

A2. The method of embodiment A1, further comprising:
determining an address for the token arbitration server based on the purchase payment information.

A3. The method of embodiment A2, wherein the address for the token arbitration server is determined by querying a database using data extracted from the purchase payment information.

A4. The method of embodiment A3, wherein the data extracted from the purchase payment information includes a portion of a user card account number.

A5. The method of embodiment A1, wherein the client device is a mobile device.

A6. The method of embodiment A1, wherein the tokenization invitation request includes the purchase payment information.

A7. The method of embodiment A1, wherein the token arbitration server is included within a payment network.

A8. A payment tokenization enrollment means, comprising:
means for obtaining a purchase order from a client device of a user;
means for extracting purchase payment information from the purchase order message;
means for determining that the user is not enrolled for payment tokenization services based on the purchase payment information;
means for generating a tokenization invitation request; and
means for providing the tokenization invitation request to a token arbitration server.

A9. The means of embodiment A8, further comprising:
means for determining an address for the token arbitration server based on the purchase payment information.

A10. The means of embodiment A9, wherein the address for the token arbitration server is determined by querying a database using data extracted from the purchase payment information.

A11. The means of embodiment A10, wherein the data extracted from the purchase payment information includes a portion of a user card account number.

A12. The means of embodiment A8, wherein the client device is a mobile device.

A13. The means of embodiment A8, wherein the tokenization invitation request includes the purchase payment information.

A14. The means of embodiment A8, wherein the token arbitration server is included within a payment network.

A15. A payment tokenization enrollment system embodiment, comprising:

a processor; and

a memory disposed in communication with the processor and storing processor-executable instructions to:
obtain a purchase order from a client device of a user;
extract purchase payment information from the purchase order message;
determine that the user is not enrolled for payment tokenization services based on the purchase payment information;
generate a tokenization invitation request; and
provide the tokenization invitation request to a token arbitration server.

A16. The system of embodiment A15, the memory further storing instructions to:
determine an address for the token arbitration server based on the purchase payment information.

A17. The system of embodiment A16, wherein the address for the token arbitration server is determined by querying a database using data extracted from the purchase payment information.

A18. The system of embodiment A17, wherein the data extracted from the purchase payment information includes a portion of a user card account number.

A19. The system of embodiment A15, wherein the client device is a mobile device.

A20. The system of embodiment A15, wherein the tokenization invitation request includes the purchase payment information.

A21. The system of embodiment A15, wherein the token arbitration server is included within a payment network.

A22. A processor-readable tangible medium embodiment storing processor-executable payment tokenization enrollment instructions to:
obtain a purchase order from a client device of a user;
extract purchase payment information from the purchase order message;
determine that the user is not enrolled for payment tokenization services based on the purchase payment information;
generate a tokenization invitation request; and
provide the tokenization invitation request to a token arbitration server.

A23. The medium of embodiment A22, further storing instructions to:
determine an address for the token arbitration server based on the purchase payment information.

A24. The medium of embodiment A23, wherein the address for the token arbitration server is determined by querying a database using data extracted from the purchase payment information.

A25. The medium of embodiment A24, wherein the data extracted from the purchase payment information includes a portion of a user card account number.

A26. The medium of embodiment A22, wherein the client device is a mobile device.

A27. The medium of embodiment A22, wherein the tokenization invitation request includes the purchase payment information.

A28. The medium of embodiment A22, wherein the token arbitration server is included within a payment network.

B1. A tokenized payment purchasing processor-implemented method embodiment, comprising:
obtaining purchase input from a user into a mobile device;
identifying a unique source-neutral universally-resolvable payment token to utilize in lieu of user financial payment information;
generating a tokenized purchase order using the purchase input and the payment token; and
providing the tokenized purchase order for processing.

B2. The method of embodiment B1, further comprising:
obtaining an indication to verify user authentication for processing tokenized purchase order;
generating a user authentication response via device fingerprinting using a hardware authentication chip embedded in the mobile device;
providing the user authentication response; and
obtaining an indication of user authentication for processing the tokenized purchase order.

B3. The method of embodiment B1, wherein the payment token is associated with a plurality of user issuer accounts.

B4. The method of embodiment B3, wherein at least one of the user issuer accounts is a stored value account.

B5. The method of embodiment B3, wherein at least one of the user issuer accounts is another payment token.

B6. The method of embodiment B1, further comprising:
obtaining a payment options request including a list of user issue accounts to utilize for processing the tokenized purchase order, after providing the tokenized purchase order for processing;
obtaining a user selection of at least one of the user issuer accounts to utilize for processing the tokenized purchase order; and
providing the user selection for processing the tokenized purchase order.

B7. The method of embodiment B6, further comprising:
obtaining a user selection of at least another of the user issuer accounts, as well as a user indication of purchase amounts to be charged to the user-selected user issuer accounts; and
providing the user selection of the user issuer accounts and the indication of the purchase amounts to be charged to the user-selected user issuer accounts.

B8. A tokenized payment purchasing means, comprising:
means for obtaining purchase input from a user into a mobile device;
means for identifying a unique source-neutral universally-resolvable payment token to utilize in lieu of user financial payment information;
means for generating a tokenized purchase order using the purchase input and the payment token; and
means for providing the tokenized purchase order for processing.

B9. The means of embodiment B8, further comprising:
means for obtaining an indication to verify user authentication for processing tokenized purchase order;
means for generating a user authentication response via device fingerprinting using a hardware authentication chip embedded in the mobile device;
means for providing the user authentication response; and
means for obtaining an indication of user authentication for processing the tokenized purchase order.

B10. The means of embodiment B8, wherein the payment token is associated with a plurality of user issuer accounts.

B11. The means of embodiment B10, wherein at least one of the user issuer accounts is a stored value account.

B12. The means of embodiment B10, wherein at least one of the user issuer accounts is another payment token.

B13. The means of embodiment B8, further comprising:
means for obtaining a payment options request including a list of user issue accounts to utilize for processing the tokenized purchase order, after providing the tokenized purchase order for processing;
means for obtaining a user selection of at least one of the user issuer accounts to utilize for processing the tokenized purchase order; and
means for providing the user selection for processing the tokenized purchase order.

B14. The means of embodiment B13, further comprising:
means for obtaining a user selection of at least another of the user issuer accounts, as well as a user indication of purchase amounts to be charged to the user-selected user issuer accounts; and
means for providing the user selection of the user issuer accounts and the indication of the purchase amounts to be charged to the user-selected user issuer accounts.

B15. A tokenized payment purchasing apparatus embodiment, comprising:

a processor; and

a memory disposed in communication with the processor and storing processor-executable instructions to:
obtain purchase input from a user into a mobile device;
identify a unique source-neutral universally-resolvable payment token to utilize in lieu of user financial payment information;
generate a tokenized purchase order using the purchase input and the payment token; and
provide the tokenized purchase order for processing.

B16. The apparatus of embodiment B15, the memory further storing instructions to:
obtain an indication to verify user authentication for processing tokenized purchase order;
generate a user authentication response via device fingerprinting using a hardware authentication chip embedded in the mobile device;
provide the user authentication response; and
obtain an indication of user authentication for processing the tokenized purchase order.

B17. The apparatus of embodiment B15, wherein the payment token is associated with a plurality of user issuer accounts.

B18. The apparatus of embodiment B17, wherein at least one of the user issuer accounts is a stored value account.

B19. The apparatus of embodiment B17, wherein at least one of the user issuer accounts is another payment token.

B20. The apparatus of embodiment B15, the memory further storing instructions to:
obtain a payment options request including a list of user issue accounts to utilize for processing the tokenized purchase order, after providing the tokenized purchase order for processing;
obtain a user selection of at least one of the user issuer accounts to utilize for processing the tokenized purchase order; and
provide the user selection for processing the tokenized purchase order.

B21. The apparatus of embodiment B20, the memory further storing instructions to:
obtain a user selection of at least another of the user issuer accounts, as well as a user indication of purchase amounts to be charged to the user-selected user issuer accounts; and
provide the user selection of the user issuer accounts and the indication of the purchase amounts to be charged to the user-selected user issuer accounts.

B22. A processor-readable tangible medium embodiment storing processor-executable tokenized payment purchasing instructions to:
obtain purchase input from a user into a mobile device;
identify a payment token to utilize in lieu of user financial payment information;
generate a tokenized purchase order using the purchase input and the payment token; and
provide the tokenized purchase order for processing.

B23. The medium of embodiment B22, further storing instructions to:
obtain an indication to verify user authentication for processing tokenized purchase order;
generate a user authentication response via device fingerprinting using a hardware authentication chip embedded in the mobile device;
provide the user authentication response; and
obtain an indication of user authentication for processing the tokenized purchase order.

B24. The medium of embodiment B22, wherein the payment token is associated with a plurality of user issuer accounts.

B25. The medium of embodiment B24, wherein at least one of the user issuer accounts is a stored value account.

B26. The medium of embodiment B24, wherein at least one of the user issuer accounts is another payment token.

B27. The medium of embodiment B22, further storing instructions to:
obtain a payment options request including a list of user issue accounts to utilize for processing the tokenized purchase order, after providing the tokenized purchase order for processing;
obtain a user selection of at least one of the user issuer accounts to utilize for processing the tokenized purchase order; and
provide the user selection for processing the tokenized purchase order.

B28. The medium of embodiment B27, further storing instructions to:
obtain a user selection of at least another of the user issuer accounts, as well as a user indication of purchase amounts to be charged to the user-selected user issuer accounts; and
provide the user selection of the user issuer accounts and the indication of the purchase amounts to be charged to the user-selected user issuer accounts.

In order to address various issues and advance the art, the entirety of this application for PAYMENT TOKENIZATION APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a PT individual and/or enterprise user, database configuration and/or relational model, data type, data transmission and/or network framework, syntax structure, and/or the like, various embodiments of the PT may be implemented that enable a great deal of flexibility and customization. For example, aspects of the PT may be adapted for compression algorithms, security systems, communications optimization, and/or the like. While various embodiments and discussions of the PT have been directed to purchase transactions, however, it is to be understood that the embodiments described herein may be readily configured and/or customized for a wide variety of other applications and/or implementations.

What is claimed is:

1. A payment token arbitration processor-implemented method, comprising:
obtaining a token arbitration request including unique source-neutral universally-resolvable payment token information from a merchant for processing a purchase order from a user;
querying a token database for issuer information on an issuer using the payment token information;
obtaining the issuer information based on querying the token database;
generating via a processor a purchase authorization request using the issuer information and data extracted from the token arbitration request; and
providing the generated purchase authorization request to the issuer.

2. The method of claim 1, further comprising:
determining that the user should be queried for payment options based on the issuer information;
generating a payment options request for the user; and
providing the payment options request to a mobile device of the user.

3. The method of claim 2, further comprising:
obtaining a response to the payment options request from the mobile device of the user;
extracting the payment options from the response;
generating purchase authorization requests for a plurality of issuers based on the payment options and pre-defined settings for issuers to be contacted for processing the purchase order from the user; and
providing the generated purchase authorization requests for the plurality of issuers.

4. The method of claim 3, wherein the issuer information includes the pre-defined settings for issuers to be contacted for processing the purchase order from the user.

5. The method of claim 2, further comprising:
providing a request for user authentication to the mobile device of the user;
obtaining a response from the mobile device to the request for user authentication;
determining that the user is authenticated to utilize the payment token information for the purchase order, based on the response to the request for user authentication; and
generating the purchase authorization request after determining that the user is authenticated to utilize the payment token information for the purchase order.

6. The method of claim 2, further comprising:
obtaining a response to the payment options request from the mobile device of the user;
extracting the payment options from the response;
generating updated pre-defined settings for issuers to be contacted for processing the purchase order from the user; and
storing the updated pre-defined settings for issuers to be contacted for processing the purchase order from the user.

7. The method of claim 1, wherein the purchase authorization request is generated using pre-defined settings included in the issuer information on issuers to be contacted for processing the purchase order from the user.

8. A payment token arbitration means, comprising:
means for obtaining a token arbitration request including unique source-neutral universally-resolvable payment token information from a merchant for processing a purchase order from a user;
means for querying a token database for issuer information on an issuer using the payment token information;
means for obtaining the issuer information based on querying the token database;
means for generating a purchase authorization request using the issuer information and data extracted from the token arbitration request; and
means for providing the generated purchase authorization request to the issuer.

9. The means of claim 9, further comprising:
means for determining that the user should be queried for payment options based on the issuer information;
means for generating a payment options request for the user; and
means for providing the payment options request to a mobile device of the user.

10. The means of claim 9, further comprising:
means for obtaining a response to the payment options request from the mobile device of the user;
means for extracting the payment options from the response;
means for generating purchase authorization requests for a plurality of issuers based on the payment options and pre-defined settings for issuers to be contacted for processing the purchase order from the user; and
means for providing the generated purchase authorization requests for the plurality of issuers.

11. The means of claim 3, wherein the issuer information includes the pre-defined settings for issuers to be contacted for processing the purchase order from the user.

12. The means of claim 9, further comprising:
means for providing a request for user authentication to the mobile device of the user;
means for obtaining a response from the mobile device to the request for user authentication;
means for determining that the user is authenticated to utilize the payment token information for the purchase order, based on the response to the request for user authentication; and
means for generating the purchase authorization request after determining that the user is authenticated to utilize the payment token information for the purchase order.

13. The means of claim 9, further comprising:
means for obtaining a response to the payment options request from the mobile device of the user;
means for extracting the payment options from the response;
means for generating updated pre-defined settings for issuers to be contacted for processing the purchase order from the user; and
means for storing the updated pre-defined settings for issuers to be contacted for processing the purchase order from the user.

14. The means of claim 8, wherein the purchase authorization request is generated using pre-defined settings included in the issuer information on issuers to be contacted for processing the purchase order from the user.

15. A payment token arbitration system, comprising:
a processor; and
a memory disposed in communication with the process and storing processor-executable instructions to:
obtain a token arbitration request including unique source-neutral universally-resolvable payment token information from a merchant for processing a purchase order from a user;
query a token database for issuer information on an issuer using the payment token information;
obtain the issuer information based on querying the token database;
generate a purchase authorization request using the issuer information and data extracted from the token arbitration request; and
provide the generated purchase authorization request to the issuer.

16. The system of claim 15, the memory further storing instructions to:
determine that the user should be queried for payment options based on the issuer information;
generate a payment options request for the user; and
provide the payment options request to a mobile device of the user.

17. The system of claim 16, the memory further storing instructions to:
obtain a response to the payment options request from the mobile device of the user;
extract the payment options from the response;
generate purchase authorization requests for a plurality of issuers based on the payment options and pre-defined settings for issuers to be contacted for processing the purchase order from the user; and
provide the generated purchase authorization requests for the plurality of issuers.

18. The system of claim 17, wherein the issuer information includes the pre-defined settings for issuers to be contacted for processing the purchase order from the user.

19. The system of claim 16, the memory further storing instructions to:
provide a request for user authentication to the mobile device of the user;
obtain a response from the mobile device to the request for user authentication;
determine that the user is authenticated to utilize the payment token information for the purchase order, based on the response to the request for user authentication; and
generate the purchase authorization request after determining that the user is authenticated to utilize the payment token information for the purchase order.

20. The system of claim 16, the memory further storing instructions to:
obtain a response to the payment options request from the mobile device of the user;
extract the payment options from the response;
generate updated pre-defined settings for issuers to be contacted for processing the purchase order from the user; and
store the updated pre-defined settings for issuers to be contacted for processing the purchase order from the user.

21. The system of claim 15, wherein the purchase authorization request is generated using pre-defined settings included in the issuer information on issuers to be contacted for processing the purchase order from the user.

22. A processor-readable tangible medium storing processor-executable payment token arbitration instructions to:
obtain a token arbitration request including payment token information from a merchant for processing a purchase order from a user;
query a token database for issuer information on an issuer using the payment token information;
obtain the issuer information based on querying the token database;
generate a purchase authorization request using the issuer information and data extracted from the token arbitration request; and
provide the generated purchase authorization request to the issuer.

23. The medium of claim 22, further storing instructions to:
determine that the user should be queried for payment options based on the issuer information;
generate a payment options request for the user; and
provide the payment options request to a mobile device of the user.

24. The medium of claim 23, further storing instructions to:
obtain a response to the payment options request from the mobile device of the user;
extract the payment options from the response;
generate purchase authorization requests for a plurality of issuers based on the payment options and pre-defined settings for issuers to be contacted for processing the purchase order from the user; and
provide the generated purchase authorization requests for the plurality of issuers.

25. The medium of claim 24, wherein the issuer information includes the pre-defined settings for issuers to be contacted for processing the purchase order from the user.

26. The medium of claim 23, further storing instructions to:
provide a request for user authentication to the mobile device of the user;
obtain a response from the mobile device to the request for user authentication;
determine that the user is authenticated to utilize the payment token information for the purchase order, based on the response to the request for user authentication; and
generate the purchase authorization request after determining that the user is authenticated to utilize the payment token information for the purchase order.

27. The medium of claim 23, further storing instructions to:
obtain a response to the payment options request from the mobile device of the user;
extract the payment options from the response;
generate updated pre-defined settings for issuers to be contacted for processing the purchase order from the user; and
store the updated pre-defined settings for issuers to be contacted for processing the purchase order from the user.

28. The medium of claim 22, wherein the purchase authorization request is generated using pre-defined settings included in the issuer information on issuers to be contacted for processing the purchase order from the user.
